(19) United States
(12) Patent Application Publication
(10) Pub. No.: US 2026/0004124 A1
(43) Pub. Date: Jan. 1, 2026

(54) METHOD AND SYSTEM FOR PREDICTING BATTERY CELL PERFORMANCE

(71) Applicant: Samsung SDI Co., Ltd., Yongin-si (KR)

(72) Inventors: Minjong Noh, Yongin-si (KR); Hakkyu Kim, Yongin-si (KR); Joonseek kim, Yongin-si (KR)

(73) Assignee: Samsung SDI Co., Ltd., Yongin-si (KR)

(21) Appl. No.: 19/065,827

(22) Filed: Feb. 27, 2025

(30) Foreign Application Priority Data
Jul. 1, 2024 (KR) 10-2024-0086143
Sep. 2, 2024 (KR) 10-2024-0118283

(51) Int. Cl. G06N 3/08

(52) U.S. Cl. CPC G06N 3/08

(57) ABSTRACT

The present disclosure relates a method for predicting battery cell performance, including: receiving one or more design factors for a target battery, determining performance-related prediction data for the target battery based on the received one or more design factors and by using a machine learning model, generating a visual representation indicating performance of the target battery based on the determined performance-related prediction data, and outputting the generated visual representation.

### CROSS-REFERENCE TO RELATED APPLICATIONS

This present application claims priority to and the benefit under 35 U.S.C. § 119(a)-(d) of Korean Patent Application No. 10-2024-0086143, filed on Jul. 1, 2024, and Korean Patent Application No. 10-2024-0118283, filed on Sep. 2, 2024, in the Korean Intellectual Property Office, the entire disclosure of which is incorporated herein by reference.

### FIELD

The present disclosure relates to a method and system for predicting battery cell performance.

### BACKGROUND

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly. Predicting battery cell specific performance indicators (e.g., state of charge (SOC), state of health (SOH), voltage, current) in advance may improve battery reliability. Also, the cost of battery cell evaluation may be reduced. In addition, predicting battery cell specific performance indicators in advance may be important in identifying improvements in battery cell design. To this end, various simulation techniques are being developed.

The above information disclosed in this Background section is for enhancement of understanding of the background of the present disclosure, and therefore, it may contain information that does not constitute related (or prior) art.

### SUMMARY

To solve the problems described herein, the present disclosure provides a method and system for predicting battery cell performance.

These and other aspects and features of the present disclosure will be described in or will be apparent from the following description of embodiments of the present disclosure.

According to some embodiments of the present disclosure, there is provided a method for predicting battery cell performance, including: receiving one or more design factors for a target battery; determining performance-related prediction data for the target battery based on the received one or more design factors and by using a machine learning model; generating a visual representation indicating performance of the target battery based on the determined performance-related prediction data; and outputting the generated visual representation.

In some embodiments, the method may further include outputting a second visual representation indicating an influence of the one or more design factors on the performance of the target battery over charge/discharge cycles of the target battery, the second visual representation being generated based on the received one or more design factors and the determined performance-related prediction data.

In some embodiments, outputting the second visual representation indicating the influence of the one or more design factors on the performance of the target battery may include: determining a first orthogonal projection by applying linear regression to the received one or more design factors and the performance of the target battery over the charge/discharge cycles of the target battery; determining a second orthogonal projection by generating the received one or more design factors multiple times and applying linear regression thereto; and determining the influence of the received one or more design factors on the performance of the target battery based on a difference between the first orthogonal projection and the second orthogonal projection.

In some embodiments, receiving the one or more design factors may include: providing a user interface for entering at least one of information about the target battery or information about a design of the target battery; and receiving the one or more new design factors for the target battery through the user interface.

In some embodiments, the one or more design factors for the target battery may include at least one of material property information of the target battery, development platform information, process manufacturing technology information, or charge/discharge configuration information.

In some embodiments, the machine learning model may include multiple machine learning models connected in a pipeline form.

In some embodiments, the multiple machine learning models may include one or more first machine learning models for a constant current (CC) charging section, one or more second machine learning models for a constant voltage (CV) charging section, one or more third machine learning models for a rest after charging section, one or more fourth machine learning models for a CC discharging section, and one or more fifth machine learning models for a rest after discharging section.

In some embodiments, the one or more first machine learning models, the one or more second machine learning models, the one or more third machine learning models, the one or more fourth machine learning models, and the one or more fifth machine learning models may be sequentially connected into a single pipeline.

In some embodiments, the one or more first machine learning models may include in the CC charging section, a machine learning model for an initial voltage, a machine learning model for a CC charging time, and a machine learning model for a voltage profile; the one or more second machine learning models may include in the CV charging section, a machine learning model for a CV charging time, and a machine learning model for a current profile; the one or more third machine learning models may include in the rest after charging section, a machine learning model for an initial voltage, a machine learning model for a final voltage, and a machine learning model for a voltage profile; the one or more fourth machine learning models may include in the CC discharge section, a machine learning model for an initial voltage, a machine learning model for a CC discharging time, and a machine learning model for a current profile; and the one or more fifth machine learning models may include in the rest after discharging section, a machine learning model for an initial voltage, a machine learning model for a final voltage, and a machine learning model for a voltage profile.

According to some embodiments of the present disclosure, there is provided a method for generating a machine learning model to predict battery cell performance, including: obtaining raw data on charge/discharge profiles of multiple batteries from a database; generating charge/discharge profile training data for the multiple batteries by preprocessing the raw data on the charge/discharge profiles of the multiple batteries; dividing the generated training data and associating the divided results with respective ones of multiple machine learning models; training the multiple machine learning models by using the divided results of the training data; and generating the machine learning model by connecting the trained multiple machine learning models into a single pipeline.

In some embodiments, the method may include: determining whether raw data on the charge/discharge profile of the battery is newly stored in the database; and generating, when it is determined that raw data on the charge/discharge profile is newly stored, the charge/discharge profile training data for the battery by performing preprocessing on the raw data for the charge/discharge profile.

In some embodiments, generating the charge/discharge profile training data may include: identifying a point in time at which CC charging is completed and CV charging starts in each of a plurality of cycles in the raw data; and assigning labels to a section of the raw data corresponding to CC charging and a section of the raw data corresponding to CV charging based on the identified point in time.

In some embodiments, the raw data for the charge/discharge profiles of the multiple batteries may include information on multiple voltages and multiple currents in each of the plurality of cycles; and the point in time at which CC charging is completed and CV charging starts may be identified based on a differential value for multiple voltages over time and a differential value for multiple currents over time.

In some embodiments, the point in time at which CC charging is completed and CV charging starts may be identified based on a point in time at which a product of the differential value for multiple voltages over time and the differential value for multiple currents over time is at a maximum.

In some embodiments, generating charge/discharge profile training data may include: removing outliers identified among numbers comprised in the raw data; and changing a specification of the raw data in correspondence to a specification of the charge/discharge profile training data.

In some embodiments, the multiple machine learning models may include one or more first machine learning models for a CC charging section, one or more second machine learning models for a CV charging section, one or more third machine learning models for a rest after charging section, one or more fourth machine learning models for a CC discharging region, and one or more fifth machine learning models for a rest after discharging section.

In some embodiments, the one or more first machine learning models may include in the CC charging section, a machine learning model for an initial voltage, a machine learning model for a CC charging time, and a machine learning model for a voltage profile; the one or more second machine learning models may include in the CV charging section, a machine learning model for a CV charging time, and a machine learning model for a current profile; the one or more third machine learning models may include in the rest after charging section, a machine learning model for an initial voltage, a machine learning model for a final voltage, and a machine learning model for a voltage profile; the one or more fourth machine learning models may include in the CC discharge section, a machine learning model for an initial voltage, a machine learning model for a CC discharging time, and a machine learning model for a current profile; and the one or more fifth machine learning models may include in the rest after discharging section, a machine learning model for an initial voltage, a machine learning model for a final voltage, and a machine learning model for a voltage profile.

In some embodiments, each of the machine learning model for predicting the voltage profile in the CC charging section, the machine learning model for predicting the current profile in the CV charging section, the machine learning model for predicting the voltage profile in the rest after charging section, the machine learning model for predicting the current profile in the CC discharging section, and the machine learning model for predicting the voltage profile in the rest after discharging section may include an artificial neural network model that predicts a profile for current or voltage based on a vector.

In some embodiments, each of the machine learning models for an initial voltage and CC charging time in the CC charging section, the machine learning model for a CV charging time in the CV charging section, the machine learning models for an initial voltage and final voltage in the rest after charging section, the machine learning models for an initial voltage and CC discharging time in the CC discharging section, the machine learning models for an initial voltage and final voltage in the rest after discharging section may include a decision tree-based ensemble model that predicts a scalar value.

According to some embodiments of the present disclosure, there is provided at least one non-transitory computer-readable recording medium storing instructions for execution by one or more processors that, when executed by the one or more processors, cause the one or more processors to perform the method according to claim 1.

According to various embodiments of the present disclosure, the user may train a machine learning prediction model by using battery design factor big data without having to directly measure battery cell performance by modifying complex battery cell design factors through experiments. Under this configuration, statistical tendencies for battery performance prediction may be extracted, and the contribution of each design factor to the battery cell performance indicator may be predicted. Accordingly, the user may be provided with an intuitively navigable API.

According to various embodiments of the present disclosure, not only charge/discharge/rest information is received from the charger/discharger data, but also CC/CV charging is provided independently, thereby providing a detailed progress environment for battery lifespan evaluation.

According to various embodiments of the present disclosure, the machine learning model may predict battery cell performance indicators for each cycle from CC/CV charging to rest according to the applied battery cell design factors, or output a voltage profile and/or a current profile. Additionally, the battery cell charge capacity may also be predicted by combining the battery cell performance indicators.

According to various embodiments of the present disclosure, the charge/discharge tendency and/or SOH of the target battery may be predicted at a stage prior to actual battery utilization, such as a design drawing stage.

According to various embodiments of the present disclosure, multiple machine learning detailed prediction models may be integrated and formed into a single pipeline. Under this configuration, the voltage profile and current profile of the target battery for each cycle may be restored and predicted more accurately by using a reductionist approach. Furthermore, the capacity of the target battery cell may also be estimated by using the predicted voltage profile and current profile.

According to various embodiments of the present disclosure, by analyzing the absolute value of the weight of each design factor to the change in the initial battery discharge capacity, the developer may identify the influence of each design factor on the SOH. This may provide the developer with information that helps to determine which design factors to be prioritized for improvement.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a schematic diagram of a battery cell performance prediction system according to some embodiments of the present disclosure,

FIG. 2 is a schematic diagram of a machine learning pipeline for the battery cell performance prediction system to predict target battery cell performance according to some embodiments of the present disclosure,

FIG. 3 is a flowchart of a machine learning pipeline for the battery cell performance prediction system to predict the target battery cell performance based on a charge/discharge profile according to some embodiments of the present disclosure,

FIG. 4 is a diagram illustrating a preprocessing process for labeling CC/CV charging according to some embodiments of the present disclosure,

FIG. 5 is a diagram illustrating a mathematical expression used to identify a CC/CV switchover point according to some embodiments of the present disclosure,

FIG. 6 is a schematic diagram illustrating an artificial neural network model for predicting battery cell performance according to some embodiments of the present disclosure,

FIG. 7 is a diagram showing a plurality of machine learning models generated according to some embodiments of the present disclosure,

FIG. 8 is a diagram showing a machine learning application point in battery charging/discharging according to some embodiments of the present disclosure,

FIGS. 9 to 11 are graphs illustrating the consistency of predicted values of the battery cell performance in the CC charging section with application of a machine learning model according to some embodiments of the present disclosure.

FIG. 12 is a diagram showing a visual representation of predicted values of battery cell performance using a machine learning model according to some embodiments of the present disclosure,

FIG. 13 is a diagram showing a visual representation of predicted values of battery cell performance obtained through a machine learning model according to some embodiments of the present disclosure,

FIG. 14 is a diagram illustrating a graph representing the influence of battery design factors on the battery cell capacity according to some embodiments of the present disclosure,

FIG. 15 is a diagram depicting a method for calculating the influence of battery design factors on the battery cell capacity according to some embodiments of the present disclosure,

FIG. 16 is a diagram illustrating a method of utilizing the influence of battery design factors on the battery cell capacity according to some embodiments of the present disclosure,

FIG. 17 is a diagram illustrating a method of utilizing the influence of battery design factors on the battery cell capacity according to some embodiments of the present disclosure,

FIG. 18 is a diagram showing a Web API-based user interface according to some embodiments of the present disclosure,

FIG. 19A is a diagram illustrating a Chat API-based user interface according to some embodiments of the present disclosure,

FIG. 19B is a schematic diagram showing a configuration in which an information processing system is connected to plural user terminals, and to provide a user interface based on Chat-API according to some embodiments of the present disclosure,

FIG. 19C is a block diagram showing the internal structure of the user terminal and the information processing system for providing a user interface based on Chat-API according to some embodiments of the present disclosure,

FIG. 20 is a flowchart illustrating a method for predicting battery cell performance according to some embodiments of the present disclosure,

FIG. 21 is a flowchart illustrating a method for generating a machine learning model to predict the battery cell performance according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average. Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Existing numerical methods may simulate physical/chemical behaviors occurring during battery cell operation by using mathematical expressions (e.g., Fick's laws, or the like). Representative methods may include an equivalent circuit model, a single particle model, a physics-based model, and a pseudo two-dimensional model. However, these existing methods may require information on the physical properties of the battery cell (capacity reduction rate, material surface information, or the like) and may require fine-tuning by experts. This may incur high costs (expert personnel, simulation resources, or the like) and may make it difficult to respond proactively.

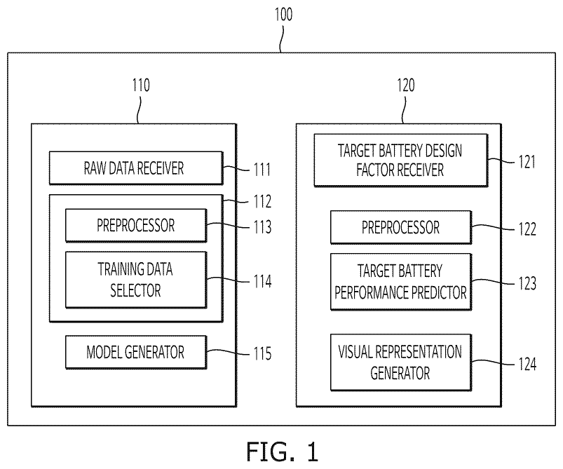

FIG. 1 is a schematic diagram of a battery cell performance prediction system according to some embodiments of the present disclosure. In an embodiment, the battery cell performance prediction system 100 may include a machine learning model generator 110 and a target battery cell performance predictor 120. For example, the battery cell performance prediction system 100 may be implemented with at least one processor.

In an embodiment, the machine learning model generator 110 may include a raw data receiver 111, a training data generator 112, and a model generator 115. Here, the training data generator 112 may include a preprocessor 113 and a training data selector 114.

In an embodiment, the raw data receiver 111 may receive, from a database, material property information, including raw data on charge/discharge configuration information including charge/discharge profiles of multiple batteries, development platform information, and/or process-related manufacturing technology information.

In an embodiment, the material property information may include not only the four battery materials including the positive electrode, negative electrode, separator, and electrolyte, but also the size of the battery cell, the positive/negative electrode loading level, the number of jelly-roll windings, the width of the pouch cell, and/or the height of the pouch cell.

In an embodiment, the material property information may include material, density, capacity, active material component ratio, binder component ratio, conductive component ratio, electrolyte component ratio, and/or thickness of the electrode foil, for the positive or negative electrode plate.

In an embodiment, the development platform information may include design voltage, current density, maximum cell layer height, maximum width, tab thickness, seal tape thickness, number of seal tapes, upper and lower tape thickness, and/or finish tape thickness, for the battery cell. Additionally, the development platform information may include the spacings between the positive electrode plate, the separator, and the negative electrode plate, thickness of the separator, punch gap, number of windings of the electrode assembly, thickness of the pouch cell, and/or thickness of the substrate tab.

In one embodiment, the charge/discharge configuration information of the battery may include initial current, end voltage, end current, charge/discharge elapsed time, resting time, charge/discharge temperature, temperature of the system in which the battery cell is stored or mounted, and/or C-rate (current rate) information in the charge/discharge of the battery cell.

In an embodiment, the training data generator 112 may perform preprocessing and data sharding so that the raw data of multiple batteries received by the raw data receiver 111 may function as training data of a machine learning model. Hence, the model generator 115 may generate a machine learning model that predicts cell performance of the battery based on the sharded training data.

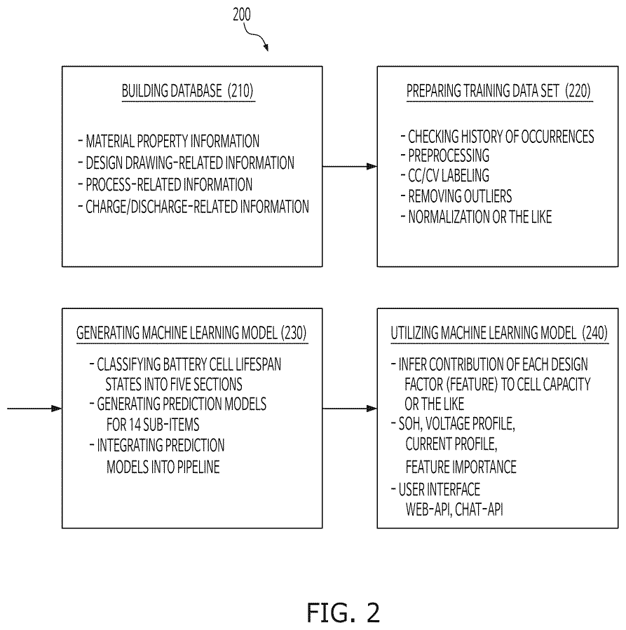

For example, the preprocessor 113 may perform CC/CV charging labeling on the raw data. Also, the preprocessor 113 may remove outliers from the raw data. In addition, the preprocessor 113 may perform normalization operations on the raw data. This will be described in detail, for example, with reference to FIG. 2 below.

In addition, the training data selector 114 may divide the preprocessed raw data according to a preset criterion and associate the results respectively with multiple machine learning models. For example, the multiple machine learning models may include machine learning detailed prediction models generated respectively for the five sections, which are obtained by dividing the battery lifespan states into five groups. For example, in the CC (constant current) charging section, the prediction models for the initial voltage, CC charging time, and voltage profile, respectively, may be included in the machine learning detailed prediction models. Additionally, in the CV (constant voltage) charging section, the prediction models for the CV charging time and current profile may be included in the machine learning detailed prediction models. Additionally, in the rest after charging section, the prediction models for the initial voltage, final voltage, and voltage profile may be included in the machine learning detailed prediction models. Additionally, in the CC discharge section, models for predicting the initial voltage, CC discharge time, and current profile may be included in the machine learning detailed prediction models. In addition, in the rest after discharge section, models for predicting the initial voltage, final voltage, and voltage profile may be included in the machine learning detailed prediction models.

In an embodiment, the target battery cell performance predictor 120 may include a target battery design factor receiver 121, a preprocessor 122, a cell performance predictor 123, and a visual display generator 124.

In an embodiment, the target battery design factor receiver 121 may receive material property information related to the material of the target battery cell, development platform information related to the design of the target battery cell, manufacturing technology information related to the process of the target battery cell, and/or charge/discharge configuration information related to the charge/discharge profile. Here, the material property information related to the material of the target battery cell, the development platform information related to the design of the target battery cell, the manufacturing technology information related to the process of the target battery cell, and the charge/discharge configuration information related to the charge/discharge profile, which are received by the target battery design factor receiver 121, may correspond to the material property information including raw data on the charge/discharge configuration information including the charge/discharge profiles of a plurality of batteries, development platform information, and the process-related manufacturing technology information, from the database received from the raw data receiver 111.

In an embodiment, the cell performance predictor 123 may determine performance-related prediction data for the target battery based on the target battery design factor values by using a machine learning model trained or generated by the machine learning model generator 110. Here, the target battery design factor values may be preprocessed by the preprocessor 122 before being input to the machine learning model to satisfy the conditions of the machine learning model input values.

In an embodiment, the visual representation generator 124 may generate a visual representation indicating the performance of the target battery based on performance-related prediction data of the target battery determined by the cell performance predictor 123. In addition, the generated visual representation may be output and provided to the user.

In FIG. 1, the preprocessor 113 in the machine learning model generator 110 and the preprocessor 122 in the target battery cell performance predictor 120 are illustrated as being implemented separately, but embodiments of the technology described herein are not limited thereto, and in some embodiments, the preprocessor 113 in the machine learning model generator 110 and the preprocessor 122 in the target battery cell performance predictor 120 may be implemented as a single preprocessing unit. In FIG. 1, the visual representation generator 124 is illustrated as being included in the target battery cell performance predictor 120, but embodiments of the technology described herein are not limited thereto, and in some embodiments, the visual representation generator 124 may be implemented separately from the target battery cell performance predictor 120.

FIG. 2 is a schematic diagram 200 of a machine learning pipeline for the battery cell performance prediction system to predict target battery cell performance according to some embodiments of the present disclosure.

According to an embodiment, a database may be constructed that stores various design factors associated with the lifespan of a battery cell (210).

In an example, the design factors of a battery cell stored in the database may include material property information related to battery cell materials, design drawing-related information related to the battery cell design, process-related information related to the battery cell process, and charge/discharge-related information related to charge/discharge profiles.

In an example, the material property information may include not only the four battery materials including the positive electrode, negative electrode, separator, and electrolyte, but also the size of the battery cell, the positive/negative electrode loading level, the number of jelly-roll windings, the width of the pouch cell, and the height of the pouch cell. Additionally, the process-related information may include temperature and pressure conditions of the battery cell manufacturing process, the angle of the blade used to cut the battery cells at a given interval (e.g., slitting), and the like. In addition, the charge/discharge related information may include voltage, current, temperature, pressure, charge/discharge elapsed time, number of charge/discharge cycles, charge/discharge profile information and conditions that directly affect the battery cell capacity.

In an example, the material property information may include density, capacity, component ratio of active material/conductor/binder/electrolyte, thickness of the electrode foil, and the like, for the positive electrode plate. Additionally, the material property information may include density, capacity, component ratio of active material (e.g., C graphite)/conductor/binder/additive, thickness of the electrode foil, and the like, for the negative electrode plate. Additionally, the material property information may include the spacings between the positive electrode plate, the separator, and the negative electrode plate, the punch gap of the separator, and the like. In addition, the material property information may also include the number of windings of the electrode assembly, the thickness of the pouch battery cell, the thickness of the substrate tab, the thickness of the seal tape, the number of seal tapes, the thickness of the cover tape, and the like.

In an example, the battery cell process related information may include the temperature of the system in which the battery cell is stored or mounted, C-rate information, and the like. Additionally, the information related to battery cell charging and discharging may also include the charge and discharge temperature.

In an example, a training data set, which is input data for generating a machine learning model, may be prepared through a preprocessing process based on the design factors stored in the database (220).

In one example, the history of occurrences may be identified from the information associated with materials, design drawings, processes, or charging/discharging stored in the database, and if there is newly generated data, preprocessing may be performed on the newly generated data, thereby preparing a training data set for training or generating a machine learning model. Here, the preprocessing process may include labeling operation on CC/CV charge states, outlier removal, and normalization.

According to an embodiment, a machine learning model may be generated based on the training data set to predict the battery cell performance (230).

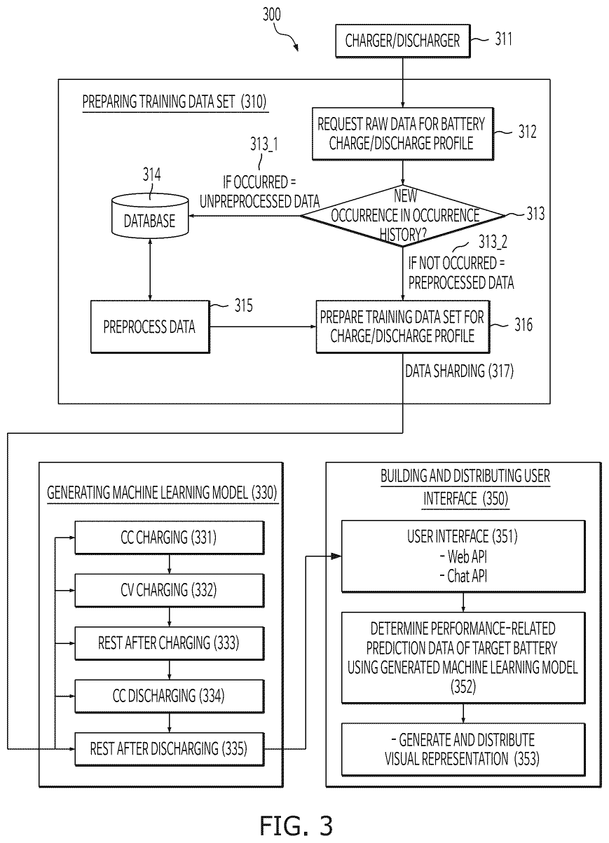

In an example, the lifespan states of the battery cell may be divided into five sections, individual section items may be classified into sub-items, and prediction models for a total of 14 sub-items may be generated as a machine learning model. Further, the prediction models for a total of 14 sub-items may be connected in sequence to each other to thereby generate a single integrated pipeline. This is further described in detail with reference to FIG. 3 below.

In an embodiment, the machine learning model generated at 230 may be utilized to predict the performance and/or lifespan of the target battery cell (240). The performance and/or lifespan of the target battery cell thus predicted may be provided via a user interface.

In an example, the design factors of a target battery cell whose lifespan is to be predicted may be applied as a feature vector to the generated machine learning model, so that the performance and/or lifespan of the target battery cell may be predicted. Here, the lifespan of the battery cell may include the state of health (SOH), the voltage profile, the current profile, and/or the contribution of each design factor to the lifespan of the target battery cell. For example, the design factors of the target battery may be input as feature vectors to the machine learning model to infer the contribution of each design factor (or feature vector) to the battery cell capacity. A visual representation for these inferred design factors may be provided through the user interface.

In an example, a user interface may be provided that allows the user to utilize the machine learning model generated in this way. For example, the user interface may be built based on Web-API, Chat-API in a chat form, or the like.

FIG. 3 is a flowchart 300 of a machine learning pipeline for the battery cell performance prediction system to predict the target battery cell performance based on a charge/discharge profile according to some embodiments of the present disclosure.

Referring to FIG. 3, the machine learning pipeline for predicting the target battery cell performance may include a step of preparing a training data set (310), a step of generating a machine learning model by using the training data set (330), and a step of generating and distributing a user interface for utilizing the generated machine learning model (350). The series of steps may be connected into an integrated pipeline. Here, the series of steps may be performed by the battery cell performance prediction system described in FIG. 1.

FIG. 3 illustrates, but is not limited to, building and utilizing a machine learning model based on information related to charging/discharging associated with prediction of the lifespan of a battery cell. For example, a series of processes for building and utilizing a machine learning model based on at least one of material-related information, design drawing-related information, or process-related information associated with predicting the lifespan of a battery cell may be performed in accordance with FIG. 3.

In an embodiment, the battery cell performance prediction system may request raw battery charge/discharge profile data from a charger/discharger 211 (312).

In an embodiment, the obtained raw data for charge/discharge profiles may be pre-processed to generate charge/discharge profile training data for at least one battery.

Here, the preprocessing step may include adding CC/CV charge labels, removing outliers, and normalizing the data so as to build a dataset usable for machine learning. First, the battery cell performance prediction system may compare the obtained raw data with previously obtained data to check whether there is a new occurrence in the history of occurrences (313).

If the raw data is determined to be newly stored (313_1), the corresponding raw data may be preprocessed to generate charge/discharge profile training data being in a form of input data to the machine learning model. The corresponding raw data may be stored in the database 314, and may be preprocessed so that it may function as input to the machine learning model (315). Accordingly, if the raw data is determined to be a new occurrence (313_1), preprocessing may be performed on the raw data (315) and the preprocessed data may be stored in a machine learning model input data pool, and a training data set for predicting the battery cell lifespan may be prepared (316).

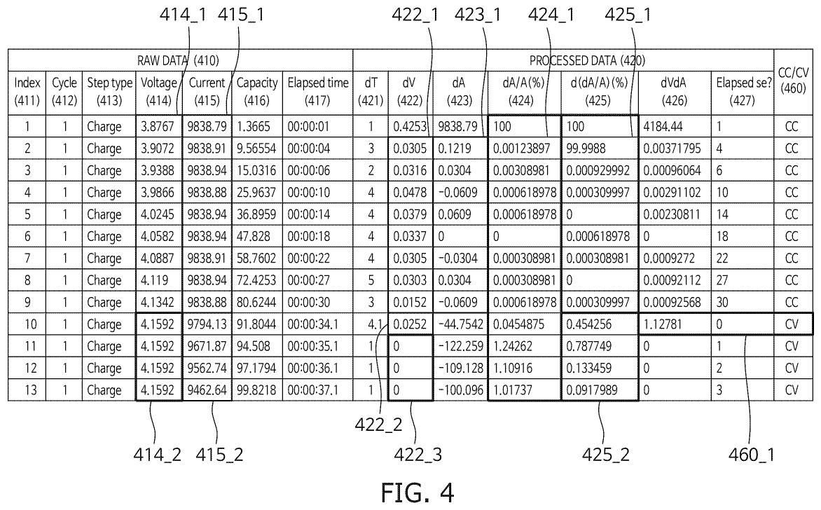

In an embodiment, data preprocessing (315) may include CC/CV charge state labeling including CC/CV switchover points, outlier removal, data normalization, and simulation domain standardization. Here, CC/CV charge state labeling is further described in detail with reference to FIG. 4 below.

In an embodiment, the outlier removal and data normalization step of the preprocessing step may include a step of removing outliers identified according to a preset criterion among the numbers included in the raw data, and changing the standard of the raw data so that it corresponds to the standard of the training data as input data to the machine learning model. For example, outlier removal may include identifying and removing outliers that occur during each cycle in consideration of the charge/discharge profile and charge/discharge temperature.

On the other hand, if the occurrence history of the raw data is identified and it is determined not to be a new occurrence (313_2), it may be seen that the raw data has already been preprocessed and stored in the database. For example, the raw data may correspond to charge/discharge profile training data, which has undergone a preprocessing step including outlier removal and standardization to include CC/CV charge labels, serving as input data to the machine learning model. Accordingly, the raw data may be stored in the machine learning model input data pool, and a training data set for predicting the battery cell lifespan may be prepared (316).

Next, the prepared training data set may be data sharded into specific groups (317). Data sharding is a technology that divides a large database into small units and stores them on multiple servers in a distributed manner. The capacity unit of the design factors that may be stored in the database in FIG. 2 and function as machine learning input variables, including the data associated with the charge/discharge profile illustrated in FIG. 3, may exceed tens of gigabytes. Hence, by distributing the machine learning data set according to specific criteria and sequentially generating machine learning models, database performance may be improved and scalability may be increased. In FIG. 3, the data preprocessing process and the data sharding process are depicted as separate processes, but without being limited thereto, the data sharding process may be included in the data preprocessing process.

Next, the battery cell performance prediction system may generate a machine learning model by using the sharded training data set. In an example, the battery lifespan states, and the battery charge/discharge states in particular, may be assumed in a multi-stage charging scheme. Additionally, a machine learning sub-model may be generated for each multi-stage charging section to predict detailed parameters.

In an embodiment, the battery charging/discharging step may include a CC (constant current) charging step (331), a CV (constant voltage) charging step (332), a rest after charging step (333), a CC discharging step (334), and a rest after discharging step (335). Here, the CC charging step (331) may be a way of charging the battery with a constant current, which is mainly used in the initial stage of battery cell charging, and may include a step of maintaining a constant current until the battery voltage reaches a preset target charging voltage. Additionally, the CV charging step (332) may be a way of charging the battery while maintaining a constant voltage, which may be initiated when the battery voltage reaches the preset target charging voltage after CC charging, and may include a step of maintaining the battery voltage at the reached target charging voltage and gradually reducing the charging current until the battery is fully charged. Additionally, the CC discharging step (334) may be a way of discharging the battery with a constant current, and may correspond to a step in which the battery is used while maintaining the current constant during the discharge process and the discharge is terminated when the battery voltage decreases to a preset target end voltage owing to battery usage. The rest after charging step (333) and the rest after discharging step (335) may include a step where no current is applied after CV charging and a step where no current is applied after discharging, respectively.

In the initial charging stage, since the battery may safely receive a high current, the CC charging step (331) that charges the battery to the target charging voltage while maintaining a constant current may be advantageous for rapid charging in the initial stage. In the CV charging step (332), when the battery voltage reaches the target charging voltage, the charging current may be reduced while maintaining the battery voltage to prevent overcharging of the battery. Additionally, the CV charging step (332) may be advantageous for extending the battery lifespan by preventing excessive heat generation or internal damage while the battery is fully charged. The CC discharging step (334) may refer to a step of consistently managing and evaluating the battery state and maintaining a stable energy supply. In the CC discharging step (334), energy supply may be stably achieved when discharging while maintaining the current at a constant value. Thereby, thermal management and voltage management may be easily performed for the battery, optimizing the battery lifespan.

Accordingly, to simulate the experimental environment for battery lifespan evaluation in relation to charging/discharging, the battery lifespan states may be classified into five sections including CC charging, CV charging, rest after charging, CC discharging, and rest after discharging.

In an embodiment, sub-models of a machine learning prediction model may be generated for each section. For example, the CC charging section may include a model for predicting at least one of the initial voltage, CC charge time, or voltage profile of the CC charging step. Additionally, the CV charging section may include a prediction model for CV charge time and/or current profile of the CV charging step. Additionally, the rest after charging section may include a prediction model for the initial voltage, final voltage, and/or voltage profile of the resting step. Additionally, the CC discharging section may include a prediction model for the initial voltage, CC discharge time, and/or current profile of the CC discharging step. Additionally, the rest after discharging section may include a prediction model for the initial voltage, final voltage, and/or voltage profile of the resting step.

In an embodiment, the rest after charging section may be a state where no current flows, and the resting time may be generally set to a preset time (e.g., 10 minutes), and a voltage drop may occur during the resting period. For the rest after charging section, a machine learning sub-model for the initial voltage, a machine learning sub-model for the final voltage, and a machine learning sub-model for the voltage profile may be generated. Accordingly, when predicting the initial voltage, final voltage, and profile shape by using the generated machine learning sub-models, the voltage drop graph of the target battery may be predicted and reproduced in the rest after charging section.

In an embodiment, in the CC discharging section, a machine learning sub-model for the initial voltage that predicts the voltage drop during discharge, a machine learning sub-model for the CC discharge elapsed time, and a machine learning sub-model for the current profile may be generated. In the CC discharging section, the final voltage drop during the resting period is received as an input variable again, and the end voltage may be determined to be a specific voltage value (e.g., user input value). Accordingly, when the discharge elapsed time and profile shape are predicted by using the generated machine learning sub-models, the current graph of the target battery can be reproduced in the CC discharging section.

In an embodiment, in the rest after discharge section, the resting period is generally set to a preset time (e.g., 10 minutes), and the voltage may be recovered during the resting period. In the rest after discharging section, a machine learning sub-model for the initial voltage, a machine learning sub-model for the final voltage, and a machine learning sub-model for the voltage profile may be generated. Accordingly, by using the machine learning sub-models generated in this way to predict the initial voltage, final voltage, and profile shape, the voltage rise graph of the target battery may be predicted and reproduced.

Thereafter, the multiple machine learning models generated in this manner may be integrated into a series of pipelines, and a user interface that makes the integrated machine learning model usable may be generated and distributed.

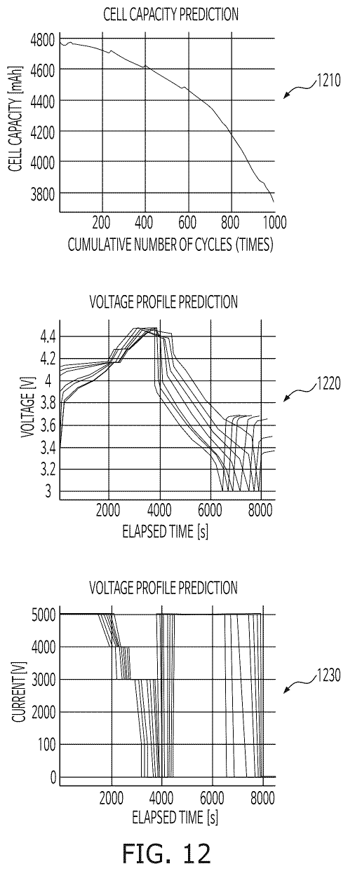

Here, the user interface may include an interface based on Web API and/or Chat API. The user may input design factors of a target battery whose lifespan state is to be predicted through a user interface. The battery lifespan prediction system may determine performance-related prediction data of the target battery by inputting the design factors of the target battery to the machine learning model (352). In addition, the battery lifespan prediction system may generate and distribute a user-friendly visual representation of the determined prediction data (353). The user interface is further described in detail with reference to FIG. 12 below.

Through this configuration, the user may train a machine learning prediction model by using battery design factor big data without having to directly measure battery cell performance by modifying complex battery cell design factors through experiments. Under this configuration, statistical tendencies for battery performance prediction may be extracted, and the contribution of each design factor to the battery cell performance indicator may be predicted. Accordingly, the user may be provided with an intuitively navigable API.

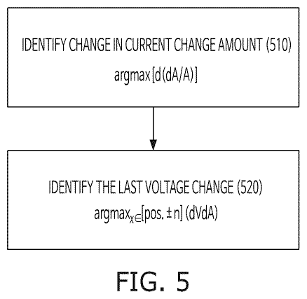

FIG. 4 is a diagram illustrating a preprocessing process for labeling CC/CV charging according to some embodiments of the present disclosure. FIG. 5 is a diagram illustrating a mathematical expression used to identify a CC/CV switchover point according to some embodiments of the present disclosure.

In an embodiment, battery cell charging may include CC charging and CV charging steps. Here, CC charging may be useful for rapid charging and may refer to a charging scheme that maintains the input current constant until the battery voltage reaches a preset target charging voltage. In addition, CV charging may be useful for improving battery stability and may refer to a charging scheme in which, after the preset target charging voltage is reached, the input current is lowered until it reaches a preset target current. In other words, to simultaneously achieve the aspects of improving the charging speed and stability of the battery, it is possible to utilize a multi-stage charging method that alternates CC charging and CV charging multiple times. Accordingly, after receiving raw charge/discharge profile information of the battery cell design factors from the charger/discharger, before training and/or inferring the machine learning model, each piece of the raw data needs to be preprocessed to determine the section among the CC charging section and the CV charging section to which it belongs in the machine learning prediction model.

In an embodiment, as illustrated, by using processed data 420 generated from raw charger/discharger data 410 received from the charger/discharger, the CC/CV switchover point may be identified, and the raw charger/discharger data 410 may be divided into CC charging section and CV charging section and labeled correspondingly.

In an embodiment, the raw charger/discharger data 410 received from the charger/discharger may include multiple data sets, each of which may include index 411, number of cycles 412, charge/discharge type 413, voltage 414, current 415, charging capacity 416, and elapsed time 417. Here, the index 411 may include sequence information of the corresponding data set, and the number of cycles 412 may include information on the number of charge/discharge cycles included in the corresponding data set. Additionally, the charge/discharge type 413 may include information on whether the corresponding data set corresponds to a charge step or a discharge step, and the elapsed time 417 may include information on how much time has elapsed since the battery charging/discharging began up to the corresponding data set.

In one embodiment, the processed data 420 may include elapsed time change amount (dT) 421, voltage change amount (dV) 422, current change amount (dA) 423, normalized current change amount (dA/A) 424, change amount of normalized current change amount (d(dA/A)) (425), product of voltage change amount and current change amount (dVdA) (426), and cumulative elapsed time 427.

In an embodiment, the elapsed time change amount 421 of the processed data 420 may be derived by using the interval between elapsed times 417 of the raw data 410. Additionally, the voltage change amount 422 may be derived by using the interval (e.g., the difference) between voltages 414. Additionally, the current change amount 423 may be derived by using the interval (e.g., the difference) between currents 415. Additionally, the normalized current change amount 424 may be derived by using a combination of current 415 and current change amount 423 (e.g., any combination thereof, including, for example a product of current 415 and current change amount 423). Additionally, the change amount of normalized current change amount (425) may be derived by using the interval (e.g., the difference) between normalized current change amounts 424. Additionally, the product of voltage change amount and current change amount (dVdA) (426) may be derived by using a combination (e.g., the product) of voltage change amount 422 and current change amount 423.

In an embodiment, the CC/CV switchover point may be determined based on the final voltage of CC charging or the initial voltage of CV charging, the amount of change in voltage, the amount of change in current, the amount of change in current change amount, and the product of the amount of change in current and the amount of change in current.

The CC/CV switchover point may refer to the point in time when a constant input current is applied and the voltage reaches a preset target charging voltage, or the point in time when the current begins to decrease to a preset target current while the voltage is maintained at the preset target charging voltage. That is, the CC/CV switchover point may refer to the end point of the CC charging section and the start point of the CV charging section.

In theory, the CC charging section may refer to a section where the current is constant at a specific value, and the amount of change in current over time should be 0 (dA=0) in that section. Additionally, the CV charging section may refer to a section where the voltage is constant at a specific value, and the amount of change in voltage over time should be 0 (dV=0) in that section.

However, as noise or the like may be involved in actual battery charging/discharging, the theoretically set target charging voltage in the CC charging section or the theoretically set target initial voltage maintained in the CV charging section may be measured differently from the actual charging voltage at the charger/discharger. In addition, the amount of change in current over time derived actually from the charger/discharger may be not calculated as exactly 0.

For example, referring to FIG. 4, the current value 415_1 measured as the actually applied current during CC charging may be not maintained constant. Consequently, the current change amount 423_1 in the CC charging section may be not maintained at 0.

In addition, referring to FIG. 4, even if the target charging voltage is set to 4.16 V during CV charging, the voltage actually measured in the charger/discharger may correspond to 4.1592 V (e.g., voltage values indicated by 414_2). Hence, if the target charging voltage is input as 4.16 V to find the CC/CV switchover point from the voltages actually measured in the CC charging section (e.g., voltage values indicated by 414_1) and the voltages actually measured in the CV charge section (e.g., voltage values indicated by 414_2), results that are different from the actual data may be derived.

It is possible to utilize the characteristic where, when the battery charge state is switched from the CC charging section to the CV charging section, the current is maintained at a fixed set current value in the CC charging section and then begins to decrease in the CV charging section, and the voltage increases to a preset target charging voltage in the CC charging section and then maintains the preset target charging voltage in the CV charging section. However, in addition to theoretical characteristics of the charger/discharger, characteristics that may occur during actual charging/discharging (e.g., noise, etc.) need to be considered when determining the CC/CV switchover point.

The CC/CV switchover point may be determined by identifying clear CC and CV charging sections, searching for candidate sections for the CC/CV switchover point, and/or applying specific rules in the corresponding candidate section.

In an embodiment, the voltage change amount 422 may be used as processed data based on the voltage 414 of the raw data 410 to clearly identify the CV charging section.

For example, the voltage corresponding to a portion 422_3 where the voltage change amount 422 is 0 may be extracted (e.g., voltage values indicated by 414_2). So, the final voltage of CC charging or the initial voltage of CV charging is not determined to be a theoretical target voltage (e.g., 4.16 V). The final voltage of CC charging or the initial voltage of CV charging may be determined to be an actual CV voltage value (e.g., 4.1592 V (414_2)) output from the charger/discharger after searching for a portion 422_3 where the voltage change amount is 0 in the CV charging section. Then, the portion 414_1 that does not correspond to the actual CV voltage value among the voltages 414 in the raw data 410 may be included in the candidates for the CC charging section. Additionally, the portion 414_2 corresponding to the actual CV voltage value may be included in the candidates for the CV charging section.

In an embodiment, the current change amount 423 may be used as processed data based on the current 415 of the raw data 410 to clearly identify the CC charging section. However, referring to FIG. 4, the current change amount 423 actually produced may be mixed as positive or negative numbers. Hence, it may be difficult to clearly identify the CC charging section by using only the current change amount 423. So, a normalized current change amount 424 obtained by dividing the current change amount 423 by the current 415 may be used.

In an embodiment, the change in current change amount may be derived with reference to FIG. 5 (S510). For example, by using the change amount 425 of the normalized current change amount 424, a local portion 425_2 where the change amount 425 of the normalized current change amount is maximum may be identified. That is, in the CC charging section, since the actual current value is maintained close to a constant value, there may be a portion 425_1 where the change amount of the normalized current change amount is not large; but in the CV charging section, since the current value decreases while the charging voltage is maintained constant, there may be a portion 425_2 where the change amount of the normalized current change amount is large. The portions 415_1 and 415_2 corresponding to portions 425_1 and 425_2 may become candidates of the CC charging section and the CV charging section, respectively.

In an embodiment, the CC/CV switchover point, i.e., the point at which CC charging is completed and CV charging starts, in the candidate portions 415_2 and 425_2 of CV charging derived using the change amount in current change amount may be identified by detecting the last voltage change with reference to FIG. 5 (S520). For example, the CC/CV switchover point may be derived to be the point 460_1 where the product of the voltage change amount and the current change amount (426) is maximized in the candidate portions 415_2 and 425_2 of CV charging.

The above-described preprocessing process may be performed by the preprocessor 113 in the machine learning model generator 110 in FIG. 1 and/or the preprocessor 122 in the target battery cell performance predictor 120.

With this configuration, the actual target voltage in the CV charging section is labeled as the target charging voltage recognized by the actual charger/discharger by using the voltage change amount, and the candidate range of the CC/CV switchover point, which is the maximum value (argmax[d(dA/A)]) of the change amount of the current change amount (d(dA/A)) in the entire range, may be identified. Then, by identifying the point where the product of the voltage change amount and the current change amount is the maximum value argmax_{x∈[pos±n]}[dVdA]) in the candidate range, the CC/CV switchover point can be identified more accurately from the raw charger/discharger data based on the processed data.

Through this configuration, not only may charge/discharge/rest information be obtained from the charger/discharger data, but CC/CV charging may also be provided independently, thereby providing a detailed practicing environment for battery lifespan evaluation.

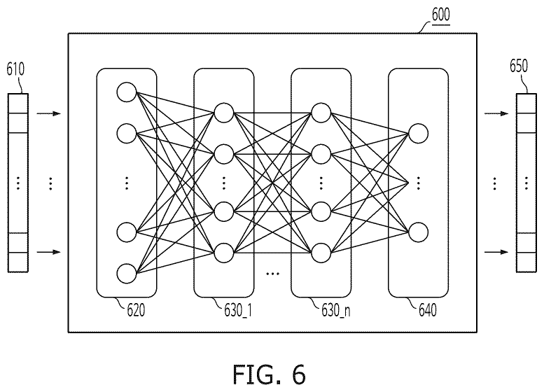

FIG. 6 is a schematic diagram illustrating an artificial neural network model for predicting battery cell performance according to some embodiments of the present disclosure. The artificial neural network model 600 is a statistical learning algorithm implemented based on the structure of a biological neural network in machine learning technology and cognitive science, or a structure that executes the algorithm. In an embodiment, the machine learning models and/or machine learning sub-models described in the present disclosure may be implemented with the artificial neural network model (600).

In an embodiment, the artificial neural network model 600 may represent a machine learning model having problem-solving capabilities by causing nodes, which are artificial neurons that form a network by combining synapses like in a biological neural network, to repeatedly adjust the weights of synapses so that the error between the correct output corresponding to a specific input and the inferred output is reduced. For example, the artificial neural network model 600 may include a probability model, neural network model, or the like used in artificial intelligence learning methods such as machine learning.

In an embodiment, the artificial neural network model 600 may include an artificial neural network model constructed to predict battery cell performance by inputting a plurality of battery design factors including charge/discharge profile information as feature vectors. When design factor information of a target battery is input to the artificial neural network model 600, a cell performance prediction result of the target battery may be output.

The artificial neural network model 600 may be implemented as a multilayer perceptron (MLP) composed of nodes in multiple layers and connections between them. The artificial neural network model 600 according to the present embodiment may be implemented by using one of various artificial neural network model structures including an MLP. As illustrated in FIG. 6, the artificial neural network model 600 may be composed of an input layer 620 that receives an input signal or data vector 610 from the outside, an output layer 640 that outputs an output signal or data vector 650 corresponding to the input data, and n (n is a positive integer) hidden layers 630_1 to 630_n that are located between the input layer 620 and the output layer 640 and are configured to receive a signal from the input layer 620, extract a characteristic, and transfer it to the output layer 640. Here, the output layer 640 may receive a signal from the hidden layers 630_1 to 630_n and output it to the outside (e.g., of the model). The learning method of the artificial neural network model 600 may include a supervised learning method that trains to optimize problem solving by receiving a teacher signal (e.g., a correct answer), and an unsupervised learning method that does not require a teacher signal. The information processing system may perform analysis on input data by using supervised learning to output battery cell performance prediction results based on multiple battery design factors including raw data on charge/discharge profiles of multiple batteries, and may train the artificial neural network model 600 so that battery cell performance prediction results corresponding to target data can be inferred.

The artificial neural network model 600 trained in this manner may be stored in a storage system, and may output a cell performance prediction result of the target battery in response to an input of a design factor of the target battery received from a user terminal having a communication interface and/or a user interface installed thereon, or from the storage system.

According to an embodiment, as illustrated in FIG. 6, the input variable of the artificial neural network model 600 capable of extracting label information may be training data including input labeling information (e.g., CC/CV switchover point labeled charge/discharge data). In this case, the input variable input to the input layer 620 of the artificial neural network model 600 may be a vector 610 that configures the training data as a single vector data element. As another example, CC/CV switchover point labeling information may be used as ground truth for training the artificial neural network model 600. In response to the input of training data including labeling information, the output variable output from the output layer 640 of the artificial neural network model 600 may be a vector 650 representing the battery cell performance prediction result. In the present disclosure, the output variable of the artificial neural network model 600 is not limited to the types described above, and may include any information/data indicating battery cell performance prediction results.

In this way, multiple input variables and corresponding multiple output variables are matched respectively to the input layer 620 and the output layer 640 of the artificial neural network model 600, and the synapse values between the nodes included in the input layer 620, the hidden layers 630_1 to 630_n, and the output layer 640 are adjusted, so that training may be performed so as to extract a correct output corresponding to a specific input. Through this training process, the characteristics hidden in the input variables of the artificial neural network model 600 may be identified, and the synapse values (or weights) between the nodes of the artificial neural network model 600 may be adjusted so that the error between the output variables calculated based on the input variables and the target output is reduced. Using the artificial neural network model 600 trained in this way, a battery cell performance prediction result corresponding to the target data may be output in response to training data including input labeling information (e.g., CC/CV switchover point labeled charge/discharge data).

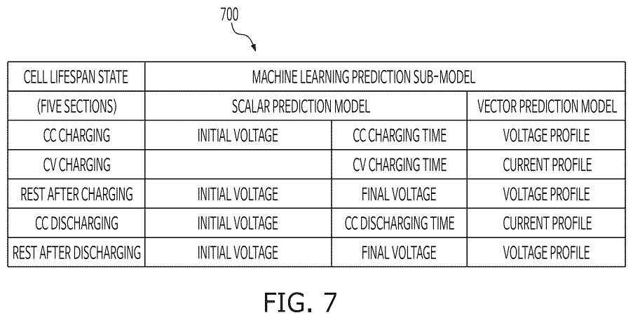

FIG. 7 is a diagram showing a plurality of machine learning models 700 generated according to some embodiments of the present disclosure. In an embodiment, machine learning prediction sub-models for each section of the battery cell lifespan states may be sequentially connected and integrated into a series of pipelines (e.g., one pipeline). Referring to FIG. 7, the machine learning prediction sub-models for each section may be divided into a scalar prediction model and a vector prediction model.

In an embodiment, the target charging voltage corresponding to the end voltage in the CC charging section is a value preset in the charger/discharger, and thus it may be not separately predicted by the machine learning model. For example, in the CC charging section, the initial voltage of charging, the CC charging elapsed time, and the voltage profile (or graph shape) may be predicted. However, in multi-stage charging, since the initial voltage after the first cycle is identical to the end voltage of the previous cycle, the machine learning model needs to predict the initial voltage of the first cycle, but may not separately predict the initial voltages of the subsequent cycles. Hence, in the CC charging section, a voltage graph of the target battery predicted in the CC charging section may be produced by using the preset final voltage, the initial voltage predicted by the machine learning model, the CC charging elapsed time, and the voltage profile.

In an embodiment, the initial voltage corresponding to the charging voltage in the CV charging section is a value preset in the charger/discharger and thus it may be not separately predicted by the machine learning model. For example, in the CV charging section, the CV charging time and current profile may be predicted. Hence, in the CV charging section, a current graph of the target battery predicted in the CC charging section may be produced by using the preset initial voltage and final voltage, and the CV charging time and current profile predicted by the machine learning model.

In an embodiment, in the rest after charging section, a current does not flow and the resting time is generally set to a preset time (e.g., 10 minutes), so the resting time may be not predicted separately. For example, in the rest after charging section, the initial voltage, final voltage, and voltage profile may be predicted. Hence, in the rest after charging section, a voltage graph of the target battery predicted in the rest after charging section may be produced by using the preset resting time, and the initial voltage, final voltage, and profile predicted by the machine learning model.

In an embodiment, in the CC discharging section, the end voltage is determined by a voltage value input to the charger/discharger, so the end voltage may be not predicted separately. For example, in the CC discharge section, the initial voltage, CC discharge time, and current profile may be predicted. Hence, in the CC discharging section, a current graph of the target battery predicted in the CC discharging section may be produced by using the initial voltage, CC discharge elapsed time, and current profile predicted by the machine learning model.

In an embodiment, in the rest after discharging section, no current flows, and the resting time is generally set to a preset time (e.g., 10 minutes), so the resting time may be not predicted separately. For example, in the rest after discharging section, the initial voltage, final voltage, and voltage profile may be predicted. Hence, in the rest after discharging section, a voltage graph of the target battery predicted in the rest after discharging section may be produced by using a preset resting time, and the initial voltage, final voltage, and voltage profile predicted by the machine learning model.

In an embodiment, among the machine learning prediction sub-models, a decision tree-based ensemble algorithm (e.g., XGBoost) may be applied to the scalar prediction model, and an artificial neural network-based algorithm (fully connected neural network) may be applied to the vector prediction model, but without being limited thereto. Under this configuration, consistency may be improved and training time and/or cost may be minimized.

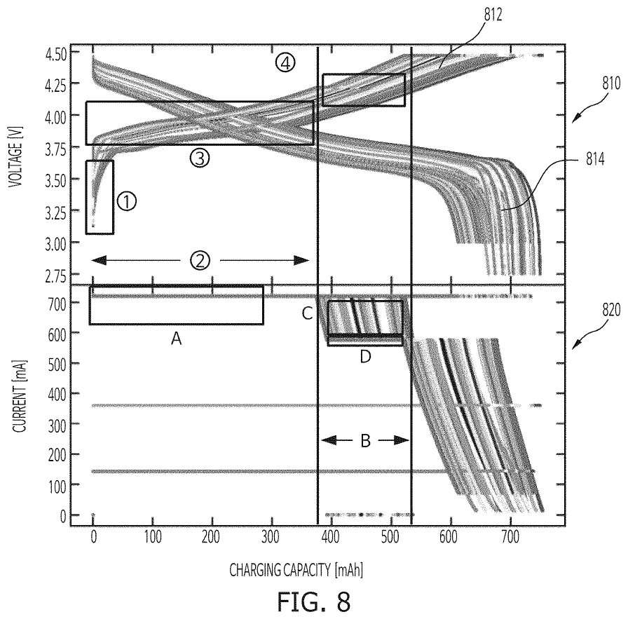

FIG. 8 is a diagram showing a machine learning application point in battery charging/discharging according to some embodiments of the present disclosure. FIG. 8 illustrates an example of a charge/discharge profile in the CC/CV charging section.

In FIG. 8, the horizontal axis in the charging/discharging graph may represent capacity, and the vertical axis may represent voltage or current. For example, among voltage graphs 810, as the charging capacity increases, the graph in which the voltage increases may correspond to a charging profile 812, and the graph in which the voltage decreases may correspond to a discharging profile 814. In addition, since the current has different directions in the charging step and the discharging step, the current profile 820 in FIG. 8 may be utilized as the current graph in the charging step and the discharging step.

The variables for the machine learning model to predict and display the charging/discharging graphs of the target battery may include eight parameters. For example, the variables may include the initial voltage, final voltage, elapsed time, and voltage curve for each section in relation to the voltage, and the initial current, final current, elapsed time, and current curve for each section in relation to the current.

In an embodiment, in the charging profile 812, \textcircled{1} may indicate the initial voltage, \textcircled{2} may indicate the elapsed time, \textcircled{3} may indicate the voltage curve, and \textcircled{4} may indicate the final voltage. Additionally, in the current profile 820, ‘A’ may indicate the initial current, ‘B’ may indicate the elapsed time, ‘C’ may indicate the current curve, and ‘D’ may indicate the final current. Here, the final voltage (or, CV charging voltage) (812, \textcircled{4}) in the CC charging section and the initial current (820, A) in the CC charging section are values that are input to the charger/discharger in advance, so they are not predicted separately, and the remaining parameters may be inferred or predicted by the machine learning model.

With the above configuration, the machine learning model may predict the battery cell performance indicators or plot the voltage profile or current profile for each cycle from CC/CV charging to resting period according to the applied battery cell design factors. Additionally, the battery cell charge capacity may also be predicted by combining the battery cell performance indicators.

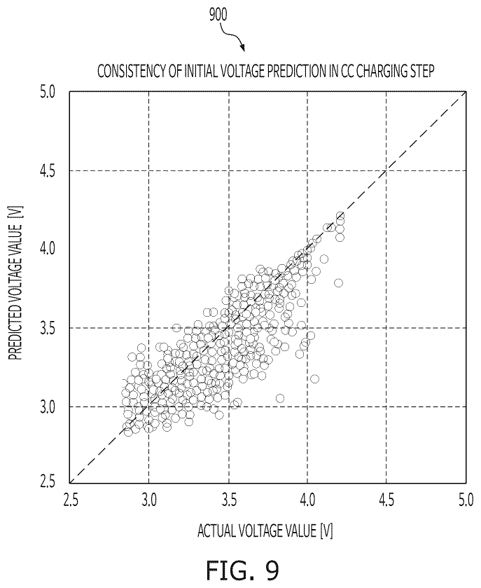

FIGS. 9 to 11 are graphs illustrating the consistency of predicted values of the battery cell performance in the CC charging section with application of a machine learning model according to some embodiments of the present disclosure.

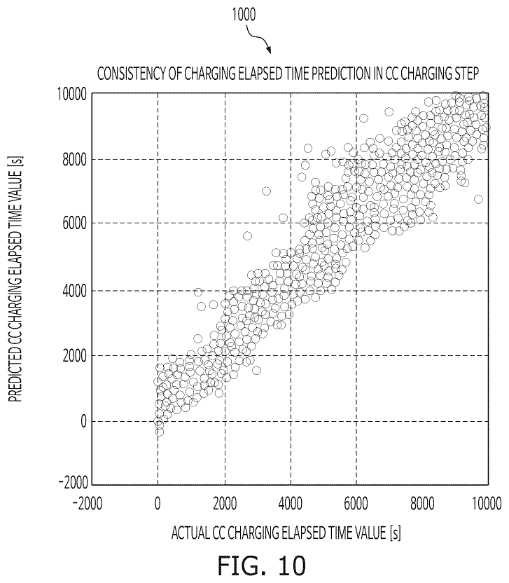

FIG. 9 illustrates a graph 900 indicating the consistency, in the CC charging section, between the CC charging initial voltage predicted by the machine learning model and the actually measured CC charging initial voltage. FIG. 10 illustrates a graph 1000 indicating the consistency, in the CC charging section, between the CC charging elapsed time predicted by the machine learning model and the actually measured CC charging elapsed time. Here, the initial voltage and charging elapsed time of the CC charging section correspond to scalars with one dependent variable item, so a decision tree-based ensemble model (e.g., XGBoost) was applied.

The decision tree-based ensemble model is a type of supervised learning being a prediction model technique that combines multiple decision trees, and may refer to a model that finds patterns in machine learning input data and perform predictions by dividing the data according to conditions. Additionally, the decision tree-based ensemble model may refer to a supervised learning technique that separates data based on conditions, and when the criteria for separating data are identified, output data may be predicted based on input data by utilizing the conditions even when new data is input.

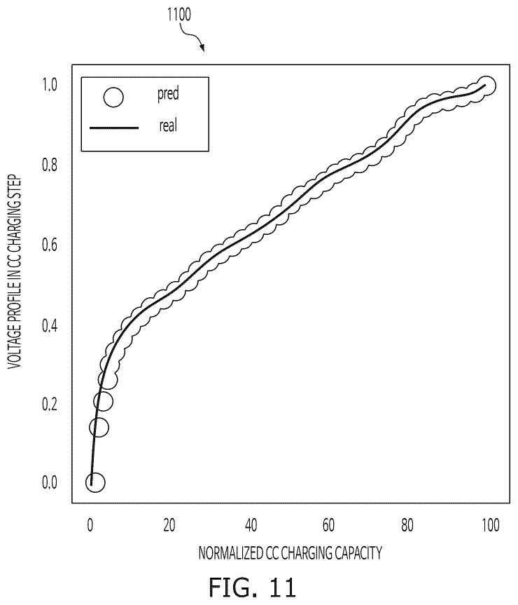

FIG. 11 illustrates a graph 1100 indicating the consistency, in the CC charging section, between the voltage profile predicted by the machine learning model and the actually measured voltage profile. Before comparing predicted values and actually measured values of the voltage profile, each data was standardized into 100 dependent variable items, and the voltage profile corresponds to a vector with multiple dependent variable items, so an artificial neural network was applied. In addition, since this is a linear regression analysis, the R2 score was used as the evaluation index.

For example, to plot a voltage profile, voltage values may be needed for each sequentially occurring cycle or interval. That is, multiple voltage values need to be predicted over time, so multiple dependent variable items may be used.

In an embodiment, the voltage profile in the CC charging section may be predicted by using an artificial neural network model (e.g., artificial neural network (ANN)). Here, the ANN is a machine learning model that imitates the human brain structure and may be included in one of the artificial neural network models described above in FIG. 6.

In an embodiment, the ANN may perform linear regression analysis by using a linear activation function in the last output layer (e.g., 640 in FIG. 6). This allows prediction of voltage values in succession.

In an embodiment, the R2 score may refer to an index for evaluating the consistency of the prediction model by using the variance ratio of the voltage profile predicted by the ANN and the actually measured voltage profile. Here, the range of the R2 score is between 0 and 1, and it may be interpreted that the closer the R2 score is to 1, the more accurately the battery performance prediction model predicts the voltage profile. In FIG. 11, the actually measured voltage profile (curve) and the predicted voltage profile (points) are displayed side by side, so that it may be interpreted that the closer the points are to the curve, the more accurately the prediction model predicts the voltage profile.

The plots of FIGS. 12 to 17 described below may be provided by the visual representation generator 124 in FIG. 1 to the user through a user interface.

FIG. 12 is a diagram showing a visual representation of predicted values of battery cell performance using a machine learning model according to some embodiments of the present disclosure.

In an embodiment, the cell capacity prediction graph 1210 is a graph visualizing the capacity efficiency of a battery cell, and the battery state over time is displayed up to 1000 cycles.

In an embodiment, the voltage profile prediction graph 1220 is a graph that visualizes the battery charge/discharge lifespan states for CC/CV charging, rest after charging, discharging, and rest after discharging at each cycle as a voltage profile, and the voltage profile prediction graph 1220 may be used to predict the battery performance.

In an embodiment, the current profile prediction graph 1230 is a graph that visualizes the battery charge/discharge lifespan states for CC/CV charging, rest after charging, discharging, and rest after discharging at each cycle as a current profile, and the current profile prediction graph 1230 may be used to predict the battery performance.

For example, the width and height of a pouch cell on the design drawing may be set as independent variables, and the width and height values on the design drawing may be assumed to be W and H, respectively. Here, when the width and/or height are each deformed by +5 mm, and are compared to the width and/or height of the pouch cell on the design drawing, the SOH may be predicted for each case where the width and/or height are deformed by +5 mm, so that the influence of each design factor on the battery cell capacity may be visually represented.

Through the above construction, the charge/discharge tendency and SOH of the target battery may be predicted at the stage before actual battery usage, such as the design drawing stage.

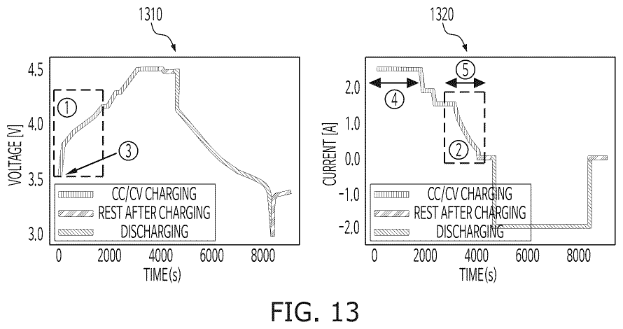

FIG. 13 is a diagram showing a visual representation of predicted values of battery cell performance obtained through a machine learning model according to some embodiments of the present disclosure. FIG. 13 illustrates a method for visualizing a voltage profile 1310 and current profile 1320 based on predicted values of target battery cell performance indicators at each cycle through a pipeline built by integrating multiple machine learning sub-models.

In an embodiment, referring to FIG. 13, the battery cell lifespan is visually depicted depending on the charge/discharge states: one cycle having three stages CC/CV charging, rest after charging, and discharging.

For example, region \textcircled{1} of the voltage profile 1310 may represent a voltage curve in the CC charging section, and region \textcircled{2} of the current profile 1320 may represent a current curve in the CV charging section. For reference, regions \textcircled{1} and \textcircled{2} may correspond to vectors.

In addition, region \textcircled{3} of the voltage profile 1310 may represent the initial voltage, and region \textcircled{4} of the current profile 1320 may represent the CC charging elapsed time in the CC charging section. Additionally, region \textcircled{5} of the current profile 1320 may represent the CV charging elapsed time in the CV charge section. For reference, regions \textcircled{3}, \textcircled{4} and \textcircled{5} may correspond to scalars.

In an embodiment, prediction of the initial voltage may be required for the CC charging section only at the first cycle. In subsequent cycles, the final voltage of the CV charging section may be used as the initial voltage of the CC charging section.

In an embodiment, at prediction step for the CC charging elapsed time (\textcircled{4} of 1320) in the CC charging section, the initial voltage (\textcircled{3} of 1310) of the CC charging section predicted in advance may be set as an independent variable. Hence, the machine learning prediction sub-model that predicts the CC charging elapsed time (\textcircled{4} of 1320) may predict the CC charging elapsed time in seconds(s).

In an embodiment, at prediction step for the CC voltage curve (\textcircled{1} of 1310) in the CC charging section, the initial voltage (\textcircled{3} of 1310) and the CC charging elapsed time (\textcircled{4} of 1320) of the CC charging section predicted in advance may be set as independent variables. However, as a CC voltage curve normalized to a preset value (e.g., normalized to 1 for both the horizontal and vertical axes) may be produced, the horizontal axis may be expanded (0˜8000) using the pre-predicted CC charging elapsed time (\textcircled{4} of 1320), and the vertical axis may be expanded (3˜5) using the pre-predicted CC initial voltage (\textcircled{3} of 1310) and the preset CC final voltage (or CV voltage) (e.g., 4.1592 V), so that the voltage curve of the actual CC charging section (\textcircled{1} of 1310) may be accurately predicted.

In an embodiment, like the voltage curve (\textcircled{1} of 1310) of the CC section, the current curve (\textcircled{2} of 1320) of the CV section can be integrated with a machine learning prediction sub-model and connected to each other. For example, based on the predetermined CC charging section current, the CV charging current elapsed time (\textcircled{5} of 1320) in the CV charging section may be predicted by the corresponding machine learning sub-model. The CV charging elapsed time (\textcircled{5} of 1320) and the current curve (\textcircled{2} of 1320) of the CV charging section may be applied to the corresponding machine learning model to produce a normalized current curve of the CV charging section. Then, the horizontal axis of the normalized current curve of the CV charging section may be expanded using the predicted CV charging elapsed time (\textcircled{5} of 1320), and the vertical axis may be expanded using the initial current and end current of the CV charging section, so that the actual current curve (\textcircled{2} of 1320) of the CV charging section may be predicted more accurately.

With the above construction, multiple machine learning prediction sub-models may be integrated and formed into a single pipeline. Under this configuration, the voltage profile and current profile of the target battery can be restored for each cycle and predicted more accurately by using a reductionist approach. Further, the capacity of the target battery cell may also be estimated by using the predicted voltage profile and current profile.

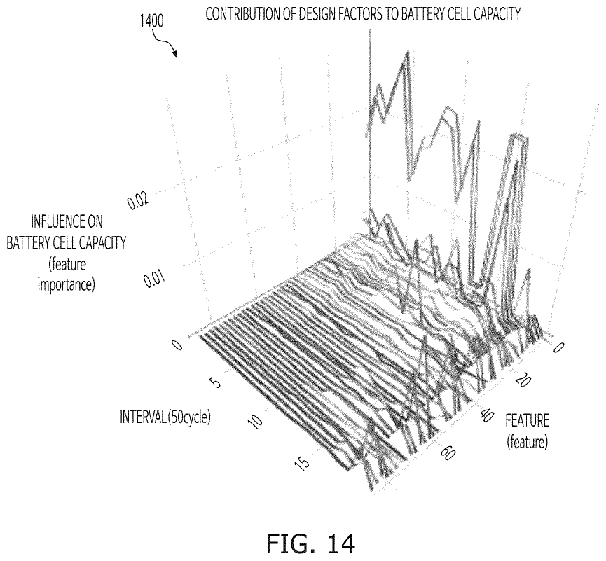

FIG. 14 is a diagram illustrating a graph 1400 representing the influence of battery design factors on the battery cell capacity according to some embodiments of the present disclosure.

In an embodiment, based on one or more design factors of the target battery and the determined performance-related prediction data, the battery cell performance prediction system may output a visual representation indicating the influence of one or more design factors of the target battery on the performance of the target battery over a charge/discharge cycle of the target battery.

In the graph 1400, the influence of each design factor on the cell capacity of the target battery is visualized every preset cycle (e.g., 50 times), so that the user can interpret which design factor affects the battery performance.

Here, the z-axis indicates the influence of each battery design factor on the battery cell capacity, with values ranging from 0 to 1, the x-axis indicates each cycle (e.g., 50 cycles), and the y-axis lists the battery design factors in order of their contribution to the battery cell capacity. Here, the battery design factors may be represented as features.

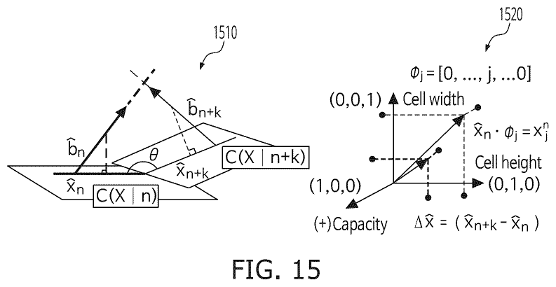

For example, the features being battery design factors may include material property information of the target battery, development platform information, manufacturing process technology information, and charge/discharge profile information. Here, the method for calculating the influence (z-axis) of each battery design factor (feature) is further described herein, for example, with reference to FIG. 15.

Through the above construction, it is possible to analyze how much each design factor affects the target battery capacity for each cycle at the design drawing stage without conducting actual experiments.

FIG. 15 is a diagram depicting a method for calculating the influence of battery design factors on the battery cell capacity according to some embodiments of the present disclosure.

In an embodiment, in the vector diagram 1510, a first orthogonal projection in space may be determined based on linear regression of one or more design factors of the target battery and performance results according to charge/discharge cycles of the target battery. Additionally, in the vector diagram 1520, one or more design factors of the target battery may be generated multiple times, and a second orthogonal projection in space may be determined based on linear regression. Then, the influence of one or more design factors of the target battery on the performance of the target battery may be determined based on the difference between the first and second orthogonal projections.

In an embodiment, referring to FIG. 15, the design factors for determining the influence on the cell capacity of the target battery may be limited to the cell width and thickness. Then, the capacity of the battery cell may be estimated by changing the cell thickness and width of the battery by a certain amount. Here, referring to the graph 1520, the capacity of the battery cell is set to x-coordinate (1,0,0), the height value of the battery cell is set to y-coordinate (0,1,0), and the thickness value of the battery cell is set to z-coordinate (0,0,1), so that multiple design factors of the battery cell and the battery cell capacity due to the corresponding design factors may be represented as a spatial capacity vector (x). The unit capacity vector normalized by the size of the spatial capacity vector (x) may be represented as (\hat{x}).

$$Similarity = cos ( θ ) = \frac{{\hat{x}}_{n} \cdot {\hat{x}}_{n + k}}{\vert {\hat{x}}_{n} \vert \cdot \vert {\hat{x}}_{n + k} \vert} \qquad [ Equation 1 ]$$

In Equation 1, the capacity vector converted into a spatial vector from the reference data reflecting n design drawings can be represented as xₙ. Additionally, when the user changes the battery design factors (e.g., width and/or thickness) to specific values, the capacity vector converted into a spatial vector may be represented as xₙ₊ₖ. Here, k may indicate that a user-designed combination of design factors is added k times to the reference capacity vector.

In an embodiment, as the user changes the multiple battery design factors, the directions of xₙ and xₙ₊ₖ may become different. Based on this characteristic, the unit vector (\hat{x}ₙ,\hat{x}ₙ₊ₖ) of each capacity vector is calculated, and the influence of each design factor on the battery capacity may be determined using the cosine similarity between unit vectors.

Here, if the cosine similarity is high, it may be interpreted as being close to the reference average data. On the other hand, if the similarity is low, the battery with a modified design factor may be interpreted as being different from the specification of the reference battery.

Through the above construction, not only can the influence of the design factors modified by the user on the battery cell capacity be determined, but information can also be provided on how much the battery reflecting the design factors modified by the user differs from the reference specification desired by the customer.

Here, the reason why the design drawing with the battery design factor changed by the user is reflected k times is as follows. For example, when k is 0, the degree of user modification to the battery design factor is 0, so it can be considered to be the same as the specification of the reference battery design factor. When there may be n (e.g., 30,000) design drawings that reflect the reference battery design factors, if only 1 new design drawing (k=1) is added that reflects the battery design factors modified by the user, and the machine learning model calculates the influence of each design factor, it may be difficult to reflect the actual results of the new design drawings in the cosine similarity result value because the number of reference design drawings (n) is greater than the number of new design drawings (k=1). Therefore, the capacity vector (xₙ₊ₖ), which reflects the user's design by a specific value (e.g., k=1000), may be utilized to derive meaningful results of the cosine similarity value according to the design factors modified by the user. That is, considering that it is difficult to significantly reflect the change rate due to the corresponding data when only one new data is reflected, weights as many as k (>1) may be set.

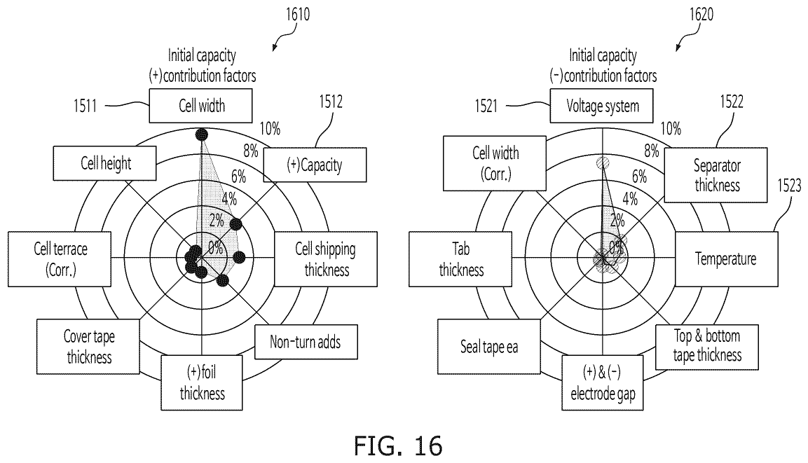

FIG. 16 is a diagram illustrating a method of utilizing the influence of battery design factors on the battery cell capacity according to some embodiments of the present disclosure. In an embodiment, the method for calculating the influence of battery design factors on the battery cell capacity described above in FIG. 15 may be applied to a battery with 0 cycles to thereby provide a model for predicting the initial discharge capacity.

For example, with the weight of linear regression analysis as the analysis target, the weight of the battery with existing design factors may be set to wₙ, and the weight of the battery with user-modified design factors may be set to xₙ₊ₖ. Then, wₙ and wₙ₊ₖ may be normalized into ŵₙ and ŵₙ₊ₖ, respectively. Using and, the cosine similarity may be calculated, and when the calculated cosine similarity is multiplied by the value of each design factor (independent variable) of the corresponding design diagram, the change rate of the battery capacity for each design factor may be calculated. Through the above construction, design factors contributing to increasing the initial capacity of the target battery cell may be estimated.

In an embodiment, the left graph 1610 may represent a case where design factors with positive weights among cosine similarities are sorted in descending order, and the right graph 1620 may represent a case where design factors with negative weights are sorted in ascending order.

Referring to the left graph 1610 in FIG. 16, the width 1511 of the battery cell may be interpreted as a design factor with positive (+) weight, positive (+) changed direction (design diagram with increased width), and increasing (+) initial capacity. On the other hand, the capacity 1512 of the battery cell has a positive (+) weight and a negative (−) changed direction (design with reduced capacity), so the capacity 1512 may be interpreted as a design factor that actually reduces (−) the initial capacity.

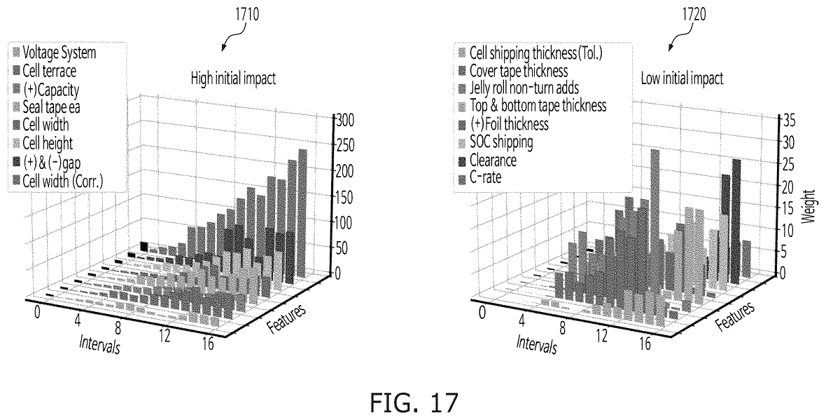

Referring to the right graph 1620 in FIG. 16, it may be seen that the voltage system 1521 has a greater weight in the negative (−) direction than the separator thickness 1522 and temperature 1523 as to the initial capacity of the battery cell. However, since the separator thickness 1522 has a negative (−) weight and a negative (−) changed direction (thickness decreases), the separator thickness 1522 may be interpreted as a design factor that increases (+) the initial capacity. On the other hand, since the voltage system 1521 or temperature 1523 has a negative (−) weight and the direction of change (e.g., increasing temperature) corresponds to an increasing (+) direction, it may be interpreted as a design factor that actually decreases (−) the initial capacity. FIG. 17 is a diagram illustrating a method of utilizing the influence of battery design factors on the battery cell capacity according to some embodiments of the present disclosure.

In an embodiment, FIG. 17 may represent the absolute value of the weight of the change in the initial discharge capacity of the battery due to each design factor at regular cycles or intervals (e.g., 50 cycles). Through the above configuration, it may be estimated which battery design factor has a relatively greater influence on the initial discharge capacity of the battery over a cycle.

In an embodiment, the left graph 1710 in FIG. 17 shows the top eight design factors for each cycle in order of the absolute value of the weight of the design factor as to the amount of change in the initial discharge capacity of the battery, and the right graph 1720 shows the bottom eight design factors for each cycle. For example, design factors (features) that have a high influence on the initial discharge capacity of the battery may show a consistent tendency over a cycle, whereas it may be difficult to identify a specific tendency for design factors (features) that have a low influence.

In an embodiment, referring to the left graph 1710, it may be interpreted that the battery cell width (Corr) has a relatively large effect on the SOH (state of health) of the battery as the cycle progresses compared to other design factors.

Through the above construction, by analyzing the absolute value of the weight of each design factor as to the amount of change in the initial discharge capacity of the battery, the developer may identify the impact of each design factor on the SOH of the battery. This provides the developer with information that helps to determine which design factors need to be improved first.

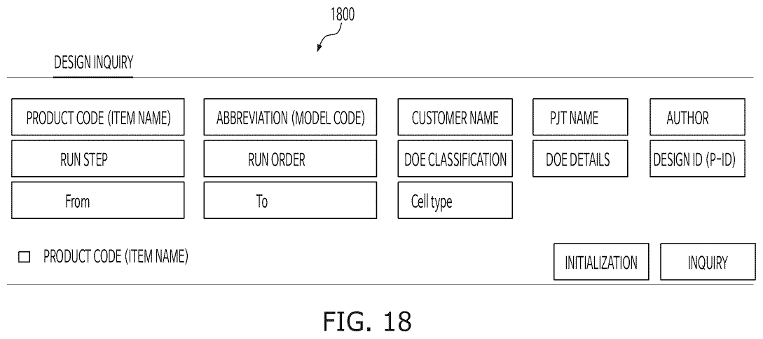

FIG. 18 is a diagram showing a Web API-based user interface according to some embodiments of the present disclosure. FIG. 18 illustrates a Web API-based user interface 1800 for entering design factors of a target battery, which includes at least one of information about the target battery or information about the design of the target battery.

Referring to FIG. 18, for the user to consider the material property information of the target battery, the product code, model code, cell type, and reference specification serving as the reference point for the characteristics of the target battery may be provided through the user interface 1800. In addition, through the user interface 1800, machine learning input data, such as customer name, project name, author name, DOE (design of experiments) classification, DOE details and design ID for considering the design drawing aspect, and run step and run order for considering the process manufacturing technology aspect may be easily found by using a query function of the user interface. However, FIG. 18 only illustrates an example of a search function on the user interface, without being limited thereto.

To improve the usability of the machine learning model generated in the battery lifespan prediction system of the present disclosure, a search function may be provided in the Web API-based user interface 1800 as shown in FIG. 18.

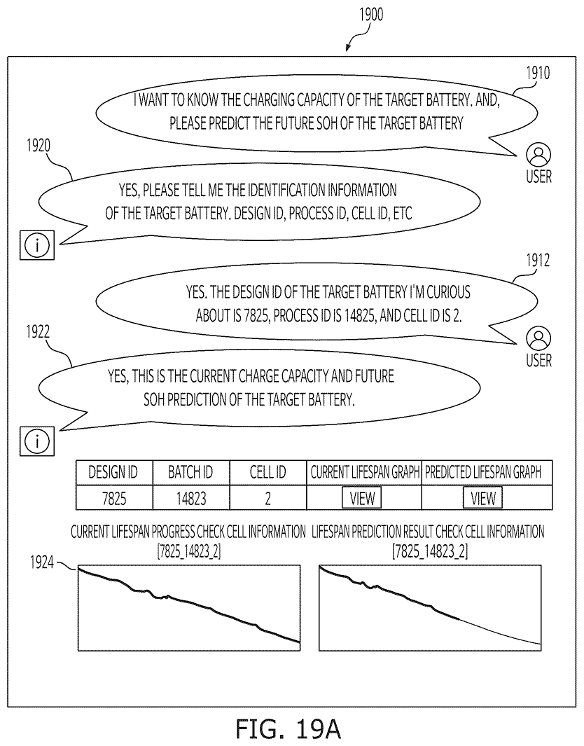

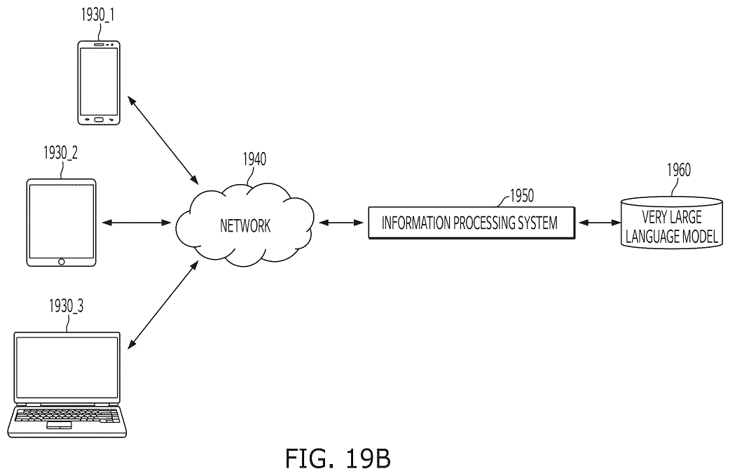

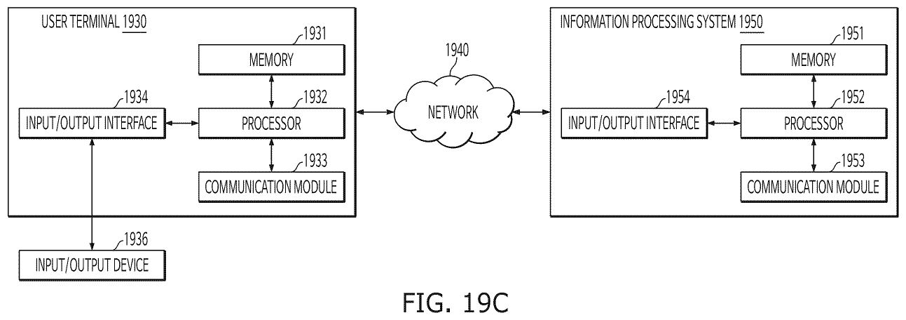

FIG. 19A is a diagram illustrating a Chat API-based user interface 1900 according to some embodiments of the present disclosure. In an embodiment, the Chat API-based user interface of the battery cell performance prediction system may be built with an NLP (natural language processing)-based API.

In an embodiment, the user may query the battery cell performance prediction system in a chat form about the performance of a battery cell the user is developing (1910) (e.g., “I want to know the charging capacity of the target battery and please predict the future SOH of the target battery”).

In an embodiment, a sentence entered through the user interface may be subject to Chain-of-Thought (CoT), a technique for inferring an answer to a specific phrase by linking multiple questions using a summary technique such as LangChain or Llama3. In an embodiment, the system may respond to the user with the cell information of the target battery (1920) (e.g., “Yes, please tell me the identification information of the target battery: design ID, process ID, cell ID, etc.”). In response to this, when a user's response to the target battery cell information (e.g., “Yes. The design ID of the target battery I'm curious about is 7825, the process ID is 14825, and the cell ID is 2”) is received (1912), input data in the form of a responsive URL may be generated. For example, input data in this URL format may be generated by a Flask server based on Web-API.

In an embodiment, input data in the form of URL may be provided to the machine learning model, and a battery cell performance prediction value in the form of JSON may be finally derived, and can be expressed as a graph of chart.js within an html page (1924) along with a response chat (1922) (e.g., “Yes, this is the current charging capacity and future SOH prediction value of the target battery.”) to the user inquiry. Through the above construction, the URL is generated in the Chat GPT format, so that the user may receive a lifespan prediction service for his/her target battery cell in a conversational format.

FIG. 19B is a schematic diagram showing a configuration in which an information processing system 1950 is connected to plural user terminals 1930_1, 1930_2 and 1930_3 to provide a user interface based on Chat-API according to some embodiments of the present disclosure.

The information processing system 1950 may include a system capable of providing a battery cell performance prediction service. In an embodiment, the information processing system 1950 may include one or more server devices and/or databases that are capable of storing, providing, and executing computer-executable programs (e.g., downloadable applications) and data in connection with a battery cell performance prediction service, or one or more distributed computing devices and/or distributed databases based on cloud computing services. For example, the information processing system 1950 may include separate systems (e.g., servers) for battery cell performance prediction services. The battery cell performance prediction service provided by the information processing system 1950 may be delivered to the users through instant messaging application, artificial intelligence-based communication software, web browser, or the like installed on the plural user terminals 1930_1, 1930_2 and 1930_3.

In an embodiment, the information processing system 1950 may provide a battery cell performance prediction service to a user terminal by using a very large language model 1960 (e.g., user interface built with NLP-based API).

The plural user terminals 1930_1, 1930_2 and 1930_3 may communicate with the information processing system 1950 through the network 1940. The network 1940 may be configured to enable communication between the plural user terminals 1930_1, 1930_2 and 1930_3 and the information processing system 1950. Depending on the installation environment, the network 1940 may be composed of, for example, a wired network such as Ethernet, wired home network (power line communication), telephone line communication or RS-serial communication, a wireless network such as mobile communication network, wireless local area network (WLAN), Wi-Fi, Bluetooth or ZigBee, or a combination thereof. There are no restrictions on communication schemes, and both communication schemes utilizing communication networks that the network 1940 can include (e.g., mobile communication network, wired Internet, wireless Internet, broadcasting network, satellite network) and short-range wireless communication between the user terminals 1930_1, 1930_2 and 1930_3 may also be included.

In FIG. 19B, a mobile phone terminal 1930_1, a tablet terminal 1930_2, and a PC terminal 1930_3 are shown as examples of user terminals; but without being limited thereto, the user terminals 1930_1, 1930_2 and 1930_3 may be any computing device that is capable of wired and/or wireless communication. For example, user terminals may include a smartphone, a mobile phone, a navigation aid, a computer, a laptop, a digital broadcasting terminal, a personal digital assistant (PDA), a portable multimedia player (PMP), a tablet PC, a game console, a wearable device, an Internet-of-things (IoT) device, a virtual reality (VR) device, and an augmented reality (AR) device. In addition, in FIG. 19B, three user terminals 1930_1, 1930_2 and 1930_3 are shown as communicating with the information processing system 1950 through the network 1940. But without being limited thereto, a different number of user terminals may be configured to communicate with the information processing system 1950 over the network 1940.

In an embodiment, the information processing system 1950 may receive user input from the user terminals 1930_1, 1930_2 and 1930_3. In FIG. 19B, the very large language model 1960 is depicted as existing outside the information processing system 1950, but without being limited thereto, the very large language model 1960 may be stored and used within the information processing system 1950. Additionally, in FIG. 19B, the information processing system (1950) is illustrated as receiving target battery design factors from a user terminal, using a machine learning model to generate target battery performance prediction values (e.g., SOH prediction graph, current lifespan graph, voltage profile, current profile, and influence of each design factor on battery capacity) and providing these values to the user terminal, but without being limited thereto, hardware/software for providing a battery cell performance prediction service may be equipped in the user terminal.

FIG. 19C is a block diagram showing the internal structure of the user terminal 1930 and the information processing system 1950 for providing a user interface based on Chat-API according to some embodiments of the present disclosure. The user terminal 1930 may refer to any computing device capable of executing an instant messaging application, artificial intelligence-based communication software, a web browser, or the like and capable of wired/wireless communication, and may include, for example, the mobile phone terminal 1930_1, tablet terminal 1930_2, and PC terminal 1930_3 in FIG. 19B. As shown, the user terminal 1930 may include a memory 1931, a processor 1932, a communication module 1933, and an input/output interface 1934. Similarly, the information processing system 1950 may include a memory 1951, a processor 1952, a communication module 1953, and an input/output interface 1954. As shown in FIG. 19C, the user terminal 1930 and the information processing system 1950 may be configured to exchange information and/or data through the network 1940 by using their communication modules 1933 and 1953. In addition, the input/output device 1936 may be configured to input information and/or data to the user terminal 1930 through the input/output interface 1934 or to output information and/or data generated from the user terminal 1930.

The memory 1931 or 1951 may include any non-transitory computer-readable recording medium. According to an embodiment, the memory 1931 or 1951 may include a permanent mass storage device such as read only memory (ROM), disk drive, solid state drive (SSD), or flash memory. As another example, a permanent mass storage device such as ROM, SSD, flash memory, or disk drive may be included in the user terminal 1930 or the information processing system 1950 as a separate permanent storage device that is distinct from the memory. In addition, the memory 1931 or 1951 may store an operating system and at least one program code.

These software components may be loaded from a computer-readable recording medium separate from the memory 1931 or 1951. This separate computer-readable recording medium may include a recording medium directly connectable to the user terminal 1930 or the information processing system 1950, and may include, for example, a computer-readable recording medium such as floppy drive, disk, tape, DVD/CD-ROM drive, or memory card. As another example, software components may be loaded onto the memory 1931 or 1951 through the communication module 1933 or 1953 other than a computer-readable recording medium. For example, at least one program may be loaded onto the memory 1931 or 1951 based on a computer program installed by files provided over the network 1940 by developers or a file distribution system that distributes installation files for applications.

The processor 1932 or 1952 may be configured to process instructions of a computer program by performing basic arithmetic, logic, and input/output operations. These instructions may be provided to the processor 1932 or 1952 by the memory 1931 or 1951 or the communication module 1933 or 1953. For example, the processor 1932 or 1952 may be configured to execute received instructions according to a program code stored in a recording device such as the memory 1931 or 1951.

The communication modules 1933 and 1953 may provide a configuration or function for the user terminal 1930 and the information processing system 1950 to communicate with each other through the network 1940, and may provide a configuration or function for the user terminal 1930 and/or the information processing system 1950 to communicate with other user terminals or other systems (e.g., separate cloud system).

For example, a request or data generated by the processor 1932 of the user terminal 1930 according to a program code stored in a recording device such as the memory 1931 may be transmitted through the network 1940 to the information processing system 1950 under the control of the communication module 1933. In reverse, a control signal or command provided under the control of the processor 1952 of the information processing system 1950 may be transmitted through the communication module 1953 over the network 1940 and received by the user terminal 1930 through the communication module 1933 of the user terminal 1930.

The input/output interface 1934 may be a means for interfacing with the input/output device 1936. As an example, input devices may include a device such as a camera including an audio sensor and/or an image sensor, a keyboard, a microphone, or a mouse, and output devices may include a device such as a display, a speaker, or a haptic feedback device. As another example, the input/output interface 1934 may be a means for interfacing with a device whose structures or functions for performing input and output are integrated into one, such as a touchscreen. In FIG. 19C, the input/output device 1936 is shown as not being included in the user terminal 1930, but without being limited thereto, the input/output device may be configured as a single device with the user terminal 1930. In addition, the input/output interface 1954 of the information processing system 1950 may be a means for interfacing with a device (not shown) for input or output that is capable of being connected to or included in the information processing system 1950. In FIG. 19C, the input/output interface 1934 or 1954 is shown as a separate component from the processor 1932 or 1952, but without being limited thereto, the input/output interface 1934 or 1954 may be configured to be included in the processor 1932 or 1952.

The user terminal 1930 or the information processing system 1950 may include more components than those shown in FIG. 19C. However, there is no need to explicitly illustrate most of related art components. In an embodiment, the user terminal 1930 may be implemented to include at least some of the input/output device 1936 described above. In addition, the user terminal 1930 may further include other components such as a transceiver, a global positioning system (GPS) module, a camera, various sensors, and a database. For example, if the user terminal 1930 is a smartphone, it may include those components included in a typical smartphone. For example, the user terminal 1930 may be implemented to further include various components such as an acceleration sensor, a gyro sensor, a microphone module, a camera module, various physical buttons, buttons using a touch panel, input/output ports, and a vibrator for vibration.

In FIGS. 19B and 19C, the user terminal and the information processing system are depicted as being connected via a network, but without being limited thereto, they may be implemented as a single computing equipment.

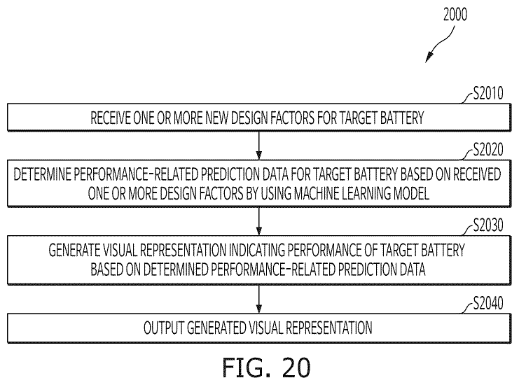

FIG. 20 is a flowchart illustrating a method 2000 for predicting battery cell performance according to some embodiments of the present disclosure.

In an embodiment, the method 2000 for predicting battery cell performance may be performed by the battery cell performance prediction system described above. Here, the battery cell performance prediction system may include a target battery design factor receiver (e.g., target battery design factor receiver 121 in FIG. 1), a preprocessor (e.g., preprocessor 122 in FIG. 1), a target battery cell performance predictor (e.g., cell performance predictor 123 in FIG. 1), and a visual representation generator (e.g., visual representation generator 124 in FIG. 1).

First, the method 2000 for predicting battery cell performance may be initiated when the target battery design factor receiver receives one or more new design factors for the target battery (S2010). Here, the one or more new design factors for the target battery may include at least one of material property information of the target battery, development platform information, process manufacturing technology information, or charge/discharge configuration information.

Additionally or alternatively, the visual representation generator may provide a user interface for inputting at least one of information about the target battery or information about the design of the target battery. Additionally, the target battery design factor receiver may receive one or more new design factors for the target battery through the user interface provided by the visual representation generator.

Next, the target battery performance predictor may determine performance-related prediction data for the target battery based on the received one or more design factors by using a machine learning model (S2020).

Here, the machine learning model may include multiple machine learning models connected in a pipeline form. For example, the multiple machine learning models may include one or more first machine learning models for the CC (constant current) charging section, one or more second machine learning models for the CV (constant voltage) charging section, one or more third machine learning models for the rest after charging section, one or more fourth machine learning models for the CC discharging section, and one or more fifth machine learning models for the rest after discharging section. In addition, the one or more first machine learning models, the one or more second machine learning models, the one or more third machine learning models, the one or more fourth machine learning models, and the one or more fifth machine learning models may be connected in sequence into a single pipeline.

For example, the one or more first machine learning models may include, in the CC charging section, a machine learning model for the initial voltage, a machine learning model for the CC charging time, and a machine learning model for voltage profile prediction. Additionally, the one or more second machine learning models may include, in the CV charging section, a machine learning model for the CV charging time, and a machine learning model for current profile prediction. In addition, the one or more third machine learning models may include, in the rest after charging section, a machine learning model for the initial voltage, a machine learning model for the final voltage, and a machine learning model for voltage profile prediction. In addition, the one or more fourth machine learning models may include, in the CC discharging section, a machine learning model for the initial voltage, a machine learning model for the CC discharge time, and a machine learning model for current profile prediction. Additionally, the one or more fifth machine learning models may include, in the rest after discharging section, a machine learning model for the initial voltage, a machine learning model for the final voltage, and a machine learning model for the voltage profile.

Next, the visual representation generator may generate a visual representation indicating the performance of the target battery based on the determined performance-related prediction data (S2030). Additionally, the visual representation generator may output the generated visual representation (S2040).

Additionally or alternatively, the visual representation generator may output a visual representation indicating the influence of one or more design factors on the performance of the target battery over charge/discharge cycles of the target battery based on the received one or more design factors and the determined performance-related prediction data.

Additionally or alternatively, the target battery performance predictor can determine a first orthogonal projection by applying linear regression to the received one or more design factors and the performance results over charge/discharge cycles of the target battery. In addition, the target battery performance predictor may determine a second orthogonal projection by generating the received one or more design factors multiple times and applying linear regression. In addition, the target battery performance predictor may determine the influence of the received one or more design factors on the performance of the target battery based on the difference between the first orthogonal projection and the second orthogonal projection.

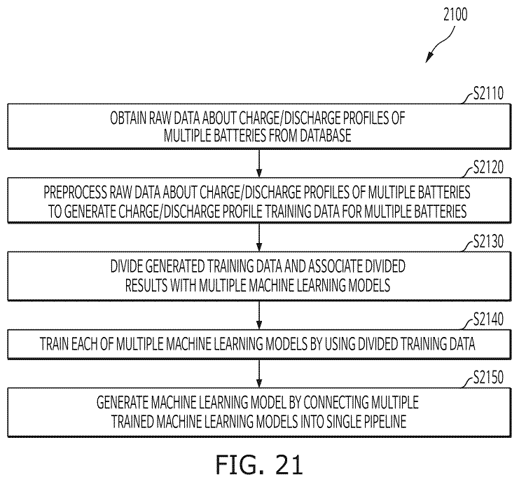

FIG. 21 is a flowchart illustrating a method for generating a machine learning model to predict the battery cell performance according to some embodiments of the present disclosure.

In an embodiment, the method for generating a machine learning model for predicting battery cell performance may be performed by the machine learning model generation system for predicting battery cell performance described above. For example, the machine learning model generation system may include a raw data receiver (e.g., raw data receiver 111 in FIG. 1), a training data generator (e.g., training data set generator 112 in FIG. 1), and a machine learning model generator 115. Additionally, the training data generator may include a preprocessor (e.g., preprocessor 113 in FIG. 1) and a training data selector (e.g., training data selector 114 in FIG. 1).

First, the raw data receiver may obtain raw data about charge/discharge profiles of multiple batteries from the database (S2110). Here, the raw data about the plural battery charge/discharge profiles obtained by the raw data receiver from the database may include at least one of a plurality of voltages, currents, capacities, charge/discharge elapsed times, or charge/discharge profiles over plural cycles.

Next, the training data generator may preprocess the raw data about the charge/discharge profiles of multiple batteries to generate charge/discharge profile training data for the multiple batteries (S2120). In addition, the training data generator may divide the generated training data and associate the results with multiple machine learning models (S2130).

For example, preprocessing of the raw data about charge/discharge profiles of multiple batteries may include identifying or labeling CC/CV switchover points, removing outliers, or normalizing data.

In an example, the training data generator may identify the CC/CV switchover point, i.e., the point in time when CC charging is completed and CV charging begins, at each of the multiple cycles included in the raw data. Additionally or alternatively, the training data generator may label the section corresponding to CC charging and the section corresponding to CV charging based on the identified CC/CV switchover points.

In an example, the training data generator may identify the CC/CV switchover point based on the differential value of multiple voltages over time and the differential value of multiple currents over time. For example, the training data generator may identify the CC/CV switchover point based on the point in time where the product of the differential value of multiple voltages over time and the differential value of multiple currents over time is at a maximum.

Additionally or alternatively, the training data generator may determine whether raw data about the charge/discharge profile of the battery is newly stored in the database. If the raw data about the charge/discharge profile is determined to be newly stored, preprocessing may be performed on the raw charge/discharge data to generate charge/discharge profile training data for the battery. Additionally, the training data generator may include the generated charge/discharge profile training data for the battery in the charge/discharge profile training data for multiple batteries.

In an example, the training data generator may remove outliers identified among the numbers included in the raw data and change the specification of the raw data in correspondence to the specification of the training data.

Next, the model generator may train each of the multiple machine learning models by using the divided training data (S2140). Next, the model generator may generate a machine learning model by connecting multiple trained machine learning models into a single pipeline (S2150).

In an example, the multiple machine learning models may include one or more first machine learning models for the CC charging section, one or more second machine learning models for the CV charging section, one or more third machine learning models for the rest after charging section, one or more fourth machine learning models for the CC discharging section, and one or more fifth machine learning models for the rest after discharging section.

For example, the one or more first machine learning models may include, in the CC charging section, a machine learning model for the initial voltage, a machine learning model for the CC charging time, and a machine learning model for voltage profile prediction. Additionally, the one or more second machine learning models may include, in the CV charging section, a machine learning model for the CV charging time, and a machine learning model for current profile prediction. In addition, the one or more third machine learning models may include, in the rest after charging section, a machine learning model for the initial voltage, a machine learning model for the final voltage, and a machine learning model for voltage profile prediction. In addition, the one or more fourth machine learning models may include, in the CC discharging section, a machine learning model for the initial voltage, a machine learning model for the CC discharge time, and a machine learning model for current profile prediction. Additionally, the one or more fifth machine learning models may include, in the rest after discharging section, a machine learning model for the initial voltage, a machine learning model for the final voltage, and a machine learning model for the voltage profile.

In an example, the machine learning model for predicting the voltage profile in the CC charging section, the machine learning model for predicting the current profile in the CV charging section, the machine learning model for predicting the voltage profile in the rest after charging section, the machine learning model for predicting the current profile in the CC discharging section, and the machine learning model for predicting the voltage profile in the rest after discharging section may each include an artificial neural network model that predicts a profile for current or voltage based on a vector. That is, a prediction model whose dependent variables correspond to a vector may apply an artificial neural network model.

In an example, the machine learning models for the initial voltage and the CC charging time in the CC charging section, the machine learning model for the CV charging time in the CV charging section, the machine learning models for the initial voltage and the final voltage in the rest after charging section, the machine learning models for the initial voltage and the CC discharging time in the CC discharging section, and the machine learning models for the initial voltage and the final voltage in the rest after discharging section may each include a decision tree-based ensemble model that predicts a scalar value. That is, a prediction model with one dependent variable corresponding to a scalar may apply a decision tree-based ensemble model.

The above-described method may be provided as a computer program stored in at least one non-transitory computer-readable recording medium for execution on a computer. Media may be used to continuously store programs executable on a computer or to temporarily store them for execution or download. Additionally, the media may be a variety of recording or storage means in the form of a single piece of hardware or a combination of several pieces of hardware, and the media may be directly connected to a certain computer system or may be distributed over a network. Examples of the media may include magnetic media such as a hard disk, floppy disk and magnetic tape, optical recording media such as CD-ROM and DVD, magneto-optical media such as floptical disk, ROM, RAM, flash memory, which may be configured to store program instructions. Additionally, examples of other media may include recording or storage media managed by app stores that distribute applications, or by sites or servers that supply or distribute various other software.

The methods, operations, or techniques of the present disclosure may be implemented with various means. For example, these techniques may be implemented in hardware, firmware, software, or a combination thereof. Those skilled in the art will understand that the various illustrative logical blocks, modules, circuits, and algorithm steps described in connection with the present disclosure may be implemented in electronic hardware, computer software, or a combination thereof. To clearly illustrate this mutual replacement between hardware and software, various illustrative components, blocks, modules, circuits, and steps have been described above generally in terms of their functionality. Whether such functionality is implemented in hardware or software depends on the specific application and design requirements imposed on the overall system. Those skilled in the art may implement the described functionality in various ways for specific applications, but such implementations should not be construed as departing from the scope of the present disclosure.

In hardware implementation, the processing units used to perform the techniques may be implemented with one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in this disclosure, computers, or a combination thereof.

Thus, the various example logical blocks, modules, and circuits described in connection with the present disclosure may be implemented with or performed by general-purpose processors, digital signal processors (DSPs), application-specific integrated circuits (ASICs), field programmable gate arrays (FPGAs), programmable logic devices, discrete gates, transistor logics, discrete hardware components, or any combination thereof designed to perform the functions described herein. A general-purpose processor may be a microprocessor, but alternatively, the processor may be any processor, controller, microcontroller, or state machine in the related art. The processors may also be implemented as a combination of computing devices, such as a DSP and a microprocessor, a plurality of microprocessors, one or more microprocessors in conjunction with a DSP core, or any other configurations.

In firmware and/or software implementation, the techniques may be implemented as instructions stored in a computer-readable medium such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), or magnetic or optical data storage device. The instructions may be executable by one or more processors, and may cause the processor(s) to perform certain aspects of the functionality described in the present disclosure.

When implemented in software, the techniques may be stored in or transmitted through computer-readable media as one or more instructions or code. The computer-readable media include both computer storage media and communication media by including any media that facilitate transfer of a computer program from one place to another. The storage media may be any available media that can be accessed by a computer. By way of non-limiting examples, these computer readable media may include RAM, ROM, EEPROM, CD-ROM or other optical disk storage, magnetic disk storage or other magnetic storage devices, or any other media that may be used to transport or store desired program codes in the form of instructions or data structures and may be accessed by a computer. In addition, random access may be suitably referred to as a computer-readable medium.

For example, if software is transmitted from a website, server, or other remote source by using coaxial cable, fiber optic cable, twisted pair cable, digital subscriber line (DSL), or wireless technologies such as infrared ray, radio wave, and microwave, these coaxial cable, fiber optic cable, twisted pair cable, digital subscriber line, or wireless technologies such as infrared ray, radio wave, and microwave may be included in the definition of media. As used herein, disks and discs include CD, laser disc, optical disc, digital versatile disc (DVD), floppy disk, and Blu-ray disc, where disks usually reproduce data magnetically, whereas discs reproduce data optically using lasers. Combinations of the above ones should also be included in the scope of computer-readable media.

Software modules may be configured to reside in RAM memory, flash memory, ROM memory, EPROM memory, EEPROM memory, registers, hard disk, removable disk, CD-ROM, or any other form of well-known storage medium. An exemplary storage medium may be coupled to a processor so that the processor may read information from or write information to the storage medium. The processor and storage medium may be present within an ASIC. The ASIC may be present in a user terminal. Alternatively, the processor and storage medium may be present as separate components in the user terminal.

Although the above-described embodiments have been described as utilizing aspects of the subject matter disclosed herein on one or more standalone computer systems, the disclosure is not limited thereto and may also be implemented in conjunction with any computing environment such as a network or distributed computing environment. Furthermore, aspects of the subject matter of this disclosure may be implemented with multiple processing chips or devices, and storage may be similarly effected across the multiple devices. These devices may include PCs, network servers, and portable devices.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A method for predicting battery cell performance, the method comprising:
receiving one or more design factors for a target battery;
determining performance-related prediction data for the target battery based on the received one or more design factors and by using a machine learning model;
generating a visual representation indicating performance of the target battery based on the determined performance-related prediction data; and
outputting the generated visual representation.

2. The method as claimed in claim 1, further comprising outputting a second visual representation indicating an influence of the one or more design factors on the performance of the target battery over charge/discharge cycles of the target battery, the second visual representation being generated based on the received one or more design factors and the determined performance-related prediction data.

3. The method as claimed in claim 2, wherein outputting the second visual representation indicating the influence of the one or more design factors on the performance of the target battery comprises:
determining a first orthogonal projection by applying linear regression to the received one or more design factors and the performance of the target battery over the charge/discharge cycles of the target battery;
determining a second orthogonal projection by generating the received one or more design factors multiple times and applying linear regression thereto; and
determining the influence of the received one or more design factors on the performance of the target battery based on a difference between the first orthogonal projection and the second orthogonal projection.

4. The method as claimed in claim 1, wherein receiving the one or more design factors comprises:
providing a user interface for entering at least one of information about the target battery or information about a design of the target battery; and
receiving the one or more new design factors for the target battery through the user interface.

5. The method as claimed in claim 1, wherein the one or more design factors for the target battery comprise at least one of material property information of the target battery, development platform information, process manufacturing technology information, or charge/discharge configuration information.

6. The method as claimed in claim 1, wherein the machine learning model comprises multiple machine learning models connected in a pipeline form.

7. The method as claimed in claim 6, wherein the multiple machine learning models comprise one or more first machine learning models for a constant current (CC) charging section, one or more second machine learning models for a constant voltage (CV) charging section, one or more third machine learning models for a rest after charging section, one or more fourth machine learning models for a CC discharging section, and one or more fifth machine learning models for a rest after discharging section.

8. The method as claimed in claim 7, wherein the one or more first machine learning models, the one or more second machine learning models, the one or more third machine learning models, the one or more fourth machine learning models, and the one or more fifth machine learning models are sequentially connected in a single pipeline.

9. The method as claimed in claim 7, wherein:
the one or more first machine learning models comprise, in the CC charging section, a machine learning model for an initial voltage, a machine learning model for a CC charging time, and a machine learning model for a voltage profile;
the one or more second machine learning models comprise, in the CV charging section, a machine learning model for a CV charging time, and a machine learning model for a current profile;
the one or more third machine learning models comprise, in the rest after charging section, a machine learning model for an initial voltage, a machine learning model for a final voltage, and a machine learning model for a voltage profile;
the one or more fourth machine learning models comprise, in the CC discharge section, a machine learning model for an initial voltage, a machine learning model for a CC discharging time, and a machine learning model for a current profile; and
the one or more fifth machine learning models comprise, in the rest after discharging section, a machine learning model for an initial voltage, a machine learning model for a final voltage, and a machine learning model for a voltage profile.

10. A method for generating a machine learning model to predict battery cell performance, the method comprising:
obtaining raw data on charge/discharge profiles of multiple batteries from a database;
generating charge/discharge profile training data for the multiple batteries by preprocessing the raw data on the charge/discharge profiles of the multiple batteries;
dividing the generated training data and associating the divided results with respective ones of multiple machine learning models;
training the multiple machine learning models by using the divided results of the training data; and
generating the machine learning model by connecting the trained multiple machine learning models into a single pipeline.

11. The method as claimed in claim 10, comprising:
determining whether raw data on the charge/discharge profile of the battery is newly stored in the database; and
generating, when it is determined that raw data on the charge/discharge profile is newly stored, the charge/discharge profile training data for the battery by performing preprocessing on the raw data for the charge/discharge profile.

12. The method as claimed in claim 10, wherein generating the charge/discharge profile training data comprises:
identifying a point in time at which constant current (CC) charging is completed and constant voltage (CV) charging starts in each of a plurality of cycles in the raw data; and
assigning labels to a section of the raw data corresponding to CC charging and a section of the raw data corresponding to CV charging based on the identified point in time.

13. The method as claimed in claim 12, wherein:
the raw data for the charge/discharge profiles of the multiple batteries comprises information on multiple voltages and multiple currents in each of the plurality of cycles; and
the point in time at which CC charging is completed and CV charging starts is identified based on a differential value for multiple voltages over time and a differential value for multiple currents over time.

14. The method as claimed in claim 13, wherein the point in time at which CC charging is completed and CV charging starts is identified based on a point in time at which a product of the differential value for multiple voltages over time and the differential value for multiple currents over time is at a maximum.

15. The method as claimed in claim 10, wherein generating charge/discharge profile training data comprises:
removing outliers identified among numbers comprised in the raw data; and
changing a specification of the raw data in correspondence to a specification of the charge/discharge profile training data.

16. The method as claimed in claim 10, wherein the multiple machine learning models comprise one or more first machine learning models for a constant current (CC) charging section, one or more second machine learning models for a constant voltage (CV) charging section, one or more third machine learning models for a rest after charging section, one or more fourth machine learning models for a CC discharging region, and one or more fifth machine learning models for a rest after discharging section.

17. The method as claimed in claim 16, wherein:
the one or more first machine learning models comprise, in the CC charging section, a machine learning model for an initial voltage, a machine learning model for a CC charging time, and a machine learning model for a voltage profile;
the one or more second machine learning models comprise, in the CV charging section, a machine learning model for a CV charging time, and a machine learning model for a current profile;
the one or more third machine learning models comprise, in the rest after charging section, a machine learning model for an initial voltage, a machine learning model for a final voltage, and a machine learning model for a voltage profile;
the one or more fourth machine learning models comprise, in the CC discharge section, a machine learning model for an initial voltage, a machine learning model for a CC discharging time, and a machine learning model for a current profile; and
the one or more fifth machine learning models comprise, in the rest after discharging section, a machine learning model for an initial voltage, a machine learning model for a final voltage, and a machine learning model for a voltage profile.

18. The method as claimed in claim 17, wherein each of the machine learning model for predicting the voltage profile in the CC charging section, the machine learning model for predicting the current profile in the CV charging section, the machine learning model for predicting the voltage profile in the rest after charging section, the machine learning model for predicting the current profile in the CC discharging section, and the machine learning model for predicting the voltage profile in the rest after discharging section comprises an artificial neural network model that predicts a profile for current or voltage based on a vector.

19. The method as claimed in claim 16, wherein each of the machine learning models for an initial voltage and CC charging time in the CC charging section, the machine learning model for a CV charging time in the CV charging section, the machine learning models for an initial voltage and final voltage in the rest after charging section, the machine learning models for an initial voltage and CC discharging time in the CC discharging section, the machine learning models for an initial voltage and final voltage in the rest after discharging section comprises a decision tree-based ensemble model that predicts a scalar value.

20. At least one non-transitory computer-readable recording medium storing instructions for execution by one or more processors that, when executed by the one or more processors, cause the one or more processors to perform the method according to claim 1.
